(19) United States
(12) Patent Application Publication
(10) Pub. No.: US 2019/0389122 A1
(43) Pub. Date: Dec. 26, 2019

(54) LAMINATING DEVICE AND METHOD FOR PRODUCING LAYERED BODY

(71) Applicant: Sharp Kabushiki Kaisha, Sakai City, Osaka (JP)

(72) Inventor: Kazuyuki NODA, Sakai City (JP)

(21) Appl. No.: 16/073,816

(22) PCT Filed: May 25, 2017
(86) PCT No.: PCT/JP2017/019472

§ 371 Date: Jul. 30, 2018

(51) Int. Cl. B29C 63/00; B29C 63/02

(52) U.S. Cl. CPC B29C 63/0047; B29C 63/02

(57) ABSTRACT

A laminating device includes a protection film facing a cover glass, a balloon pressing the protection film to a recessed surface of the cover glass by inflating, and a first regulating portion and a second regulating portion regulating inflation of a part of the balloon. In this way, air bubbles being formed are reduced, and a bonding subject is bonded to a bonded subject.

### TECHNICAL FIELD

The disclosure relates to a laminating device and a method for producing a layered body.

### BACKGROUND ART

A diaphragm method has been known as a method for bonding a film to a bonded member such as a case. In the diaphragm method, as a balloon made of rubber or the like is inflated, a film is pressed by the balloon, so that the film is bonded to a bonded member facing the film.

### CITATION LIST

### Patent Literature

PTL 1: JP 2001-255540 A

PTL 2: JP 2015-98516 A

### SUMMARY

### Technical Problem

However, a surface of the bonded member to which the film is bonded may have a recessed shape instead of being a plane.

A laminating device 101 illustrated in FIGS. 20A to 20C is a device for bonding a protection film 123 to a cover glass 113 used for a cellular phone terminal or the like. The laminating device 101 includes a mounting stand 110 on which the cover glass 113 is mounted, a protection film holding portion 120 holding the protection film 123 such that the protection film 123 faces the cover glass 113 mounted on the mounting stand 110, a balloon 105 disposed opposite to the cover glass 113 with respect to the protection film 123 and made of rubber or the like, and a balloon supporting portion 103 supporting the balloon 105.

A recessed portion 111 is formed in a region of the mounting stand 110 in which the cover glass 113 is mounted. An edge region of the recessed portion 111 is curved. The cover glass 113 mounted on the recessed portion 111 also has a recessed shape in cross section and has an edge region which is curved.

As illustrated in FIGS. 20A and 20B, a gas 107 is introduced through a through hole 103a formed in the balloon supporting portion 103, fills a space between the balloon supporting portion 103 and the balloon 105, and inflates the balloon 105.

Then, as illustrated in FIG. 20B, as the balloon 105 is inflated, the protection film 123 is pressed, and the protection film 123 is brought into contact with the cover glass 113 mounted on the mounting stand 110. An adhesive is applied to a facing surface of the protection film 123 facing the cover glass 113, and the protection film 123 is bonded to the cover glass 113 by contact with the cover glass 113.

However, a bonded surface of the cover glass 113 mounted on the mounting stand 110, to which the protection film 123 is bonded, does not have a plane and has a recessed shape curved such that an edge region rises gradually toward an edge.

Thus, as illustrated in FIG. 20C, in a process of pushing the protection film 123 by the balloon 105 and bonding it to the cover glass 113, an edge Z1 of the protection film 123 may contact and be bonded to the cover glass 113 before an inner portion Z2 of the edge Z1 of the protection film 123. In this case, even in a case where the balloon 105 is further inflated, the inner portion Z2 of the edge Z1 of the protection film 123 does not contact the cover glass 113, and air bubbles are trapped in the inner portion Z2.

The disclosure has been made in view of the above-mentioned known problems, and an object thereof is to reduce air bubbles being formed and to bond a bonding subject to a surface of a bonded subject having a recessed shape.

### Solution to Problem

To solve the above-mentioned problems, a laminating device according to one aspect of the disclosure includes: a mounting stand on which a bonded member is mounted, the bonded member including a surface having a recessed shape and to which a film is bonded; a holding portion configured to hold the film facing the bonded member mounted on the mounting stand; a balloon disposed opposite to the bonded member with respect to the film, made of an elastic material inflated by a flow of a fluid, and configured to press the film by inflating; and a regulating portion configured to regulate inflation of a part of the balloon by contacting the balloon before inflation of the balloon or in a process of inflation of the balloon.

To solve the above-mentioned problems, a method for producing a layered body according to one aspect of the disclosure is a method for producing a layered body formed by a film bonded to a bonded member. The method for producing a layered body includes: holding the film facing the bonded member, the bonded member including a surface having a recessed shape and to which the film is bonded; pressing the film by inflating a balloon disposed opposite to the bonded member with respect to the film and made of an elastic material inflated by a flow of a fluid; and regulating inflation of a part of the balloon by contacting the balloon before inflation of the balloon or in a process of inflation of the balloon.

### Advantageous Effects of Disclosure

One aspect of the disclosure can have effects of reducing air bubbles being formed and of bonding a bonding subject to a surface of a bonded subject having a recessed shape.

### BRIEF DESCRIPTION OF DRAWINGS

FIG. 1 is a cross-sectional view illustrating a configuration of a laminating device according to a first embodiment of the disclosure.

FIG. 2 is a perspective view illustrating a configuration of a mounting stand and a regulating portion of the laminating device according to the first embodiment of the disclosure.

FIG. 3A is a cross-sectional view illustrating a configuration of a main portion of the laminating device according to the first embodiment of the disclosure. FIG. 3B is a diagram illustrating a state where a balloon of the laminating device illustrated in FIG. 3A is inflated. FIG. 3C is a diagram illustrating a state where a first regulating portion and a second regulating portion of the laminating device illustrated in FIG. 3B are sliding.

FIG. 4A is a cross-sectional view illustrating a configuration of a main portion of a laminating device according to a second embodiment of the disclosure. FIG. 4B is a diagram illustrating a state where a balloon of the laminating device illustrated in FIG. 4A is inflated. FIG. 4C is a diagram illustrating a state where a first regulating portion and a second regulating portion of the laminating device illustrated in FIG. 4B are sliding.

FIG. 5A is a cross-sectional view illustrating a configuration of a main portion of a laminating device according to a third embodiment of the disclosure. FIG. 5B is a diagram illustrating a state where a balloon of the laminating device illustrated in FIG. 5A is inflated. FIG. 5C is a diagram illustrating a state where a first regulating portion and a second regulating portion of the laminating device illustrated in FIG. 5B are sliding.

FIG. 6A is a cross-sectional view illustrating a configuration of a main portion of a laminating device according to a fourth embodiment of the disclosure. FIG. 6B is a diagram illustrating a state where a balloon of the laminating device illustrated in FIG. 6A is inflated. FIG. 6C is a diagram illustrating a state where a first regulating portion and a second regulating portion of the laminating device illustrated in FIG. 6B are sliding.

FIG. 7A is a cross-sectional view illustrating a configuration of a main portion of a laminating device according to a fifth embodiment of the disclosure. FIG. 7B is a diagram illustrating a state where a balloon of the laminating device illustrated in FIG. 7A is inflated. FIG. 7C is a diagram illustrating a state where a regulating portion of the laminating device illustrated in FIG. 7B is sliding.

FIG. 8A is a cross-sectional view illustrating a configuration of a main portion of a laminating device according to a sixth embodiment of the disclosure. FIG. 8B is a diagram illustrating a state where a balloon of the laminating device illustrated in FIG. 8A is inflated. FIG. 8C is a diagram illustrating a state where a regulating portion of the laminating device illustrated in FIG. 8B is sliding.

FIG. 9A is a cross-sectional view illustrating a configuration of a main portion of a laminating device according to a seventh embodiment of the disclosure. FIG. 9B is a diagram illustrating a state where a balloon of the laminating device illustrated in FIG. 9A is inflated. FIG. 9C is a diagram illustrating a state where a regulating portion of the laminating device illustrated in FIG. 9B is sliding.

FIG. 10A is a cross-sectional view illustrating a configuration of a main portion of a laminating device according to an eighth embodiment of the disclosure. FIG. 10B is a diagram illustrating a state where a balloon of the laminating device illustrated in FIG. 10A is inflated. FIG. 10C is a diagram illustrating a state where a regulating portion of the laminating device illustrated in FIG. 10B is sliding.

FIG. 11A is a cross-sectional view illustrating a configuration of a main portion of a laminating device according to a ninth embodiment of the disclosure. FIG. 11B is a diagram illustrating a state where a balloon of the laminating device illustrated in FIG. 11A is inflated. FIG. 11C is a diagram illustrating a state where a first regulating portion and a second regulating portion of the laminating device illustrated in FIG. 11B are sliding.

FIG. 12A is a cross-sectional view illustrating a configuration of a main portion of a laminating device according to a tenth embodiment of the disclosure. FIG. 12B is a diagram illustrating a state where a balloon of the laminating device illustrated in FIG. 12A is inflated. FIG. 12C is a diagram illustrating a state where the balloon of the laminating device illustrated in FIG. 12B is further inflated.

FIG. 13 is a cross-sectional view illustrating a configuration of a laminating device according to an eleventh embodiment of the disclosure.

FIG. 14A is a cross-sectional view illustrating a configuration of a main portion of the laminating device according to the eleventh embodiment of the disclosure. FIG. 14B is a diagram illustrating a state where a balloon of the laminating device illustrated in FIG. 14A is inflated. FIG. 14C is a diagram illustrating a state where a first regulating portion and a second regulating portion of the laminating device illustrated in FIG. 14B are sliding.

FIG. 15 is a cross-sectional view illustrating a configuration of a laminating device according to a twelfth embodiment of the disclosure.

FIG. 16 is a cross-sectional view illustrating a configuration of a regulating portion of the laminating device according to the twelfth embodiment of the disclosure.

FIG. 17A is a plan view illustrating a configuration of a mounting stand of the laminating device according to the twelfth embodiment of the disclosure. FIG. 17B is a perspective view of the mounting stand illustrated in FIG. 17A.

FIG. 18 is a perspective view illustrating a configuration of a cover glass mounted on the mounting stand of the laminating device according to the twelfth embodiment of the disclosure.

FIG. 19A is a cross-sectional view illustrating a configuration of a main portion of the laminating device according to the twelfth embodiment of the disclosure. FIG. 19B is a diagram illustrating a state where a balloon of the laminating device illustrated in FIG. 19A is inflated. FIG. 19C is a diagram illustrating a state where a first regulating portion, a second regulating portion, a third regulating portion, and a fourth regulating portion of the laminating device illustrated in FIG. 19B are sliding.

FIG. 20 is a cross-sectional view illustrating a configuration of a known laminating device. FIG. 20B is a diagram illustrating a state where a balloon of the laminating device illustrated in FIG. 20A is inflated. FIG. 20C is an enlarged diagram of an edge portion of a bonding subject illustrated in FIG. 20B.

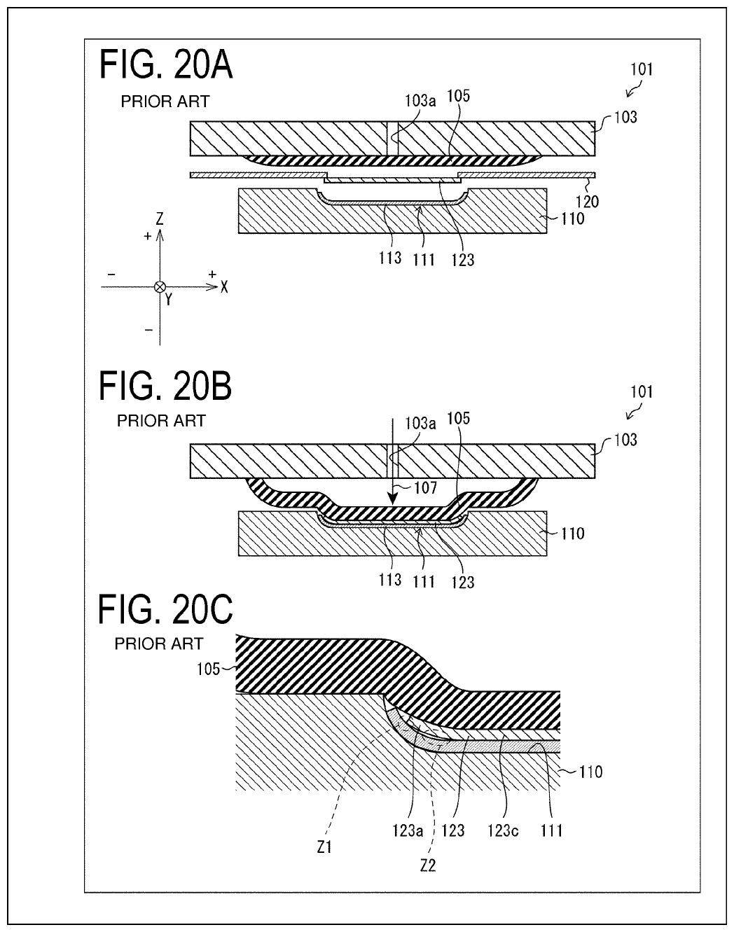

### DESCRIPTION OF EMBODIMENTS

### First Embodiment

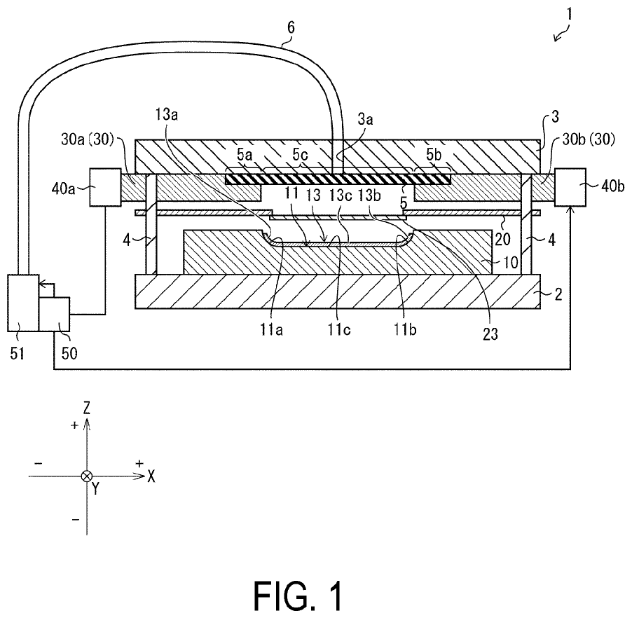

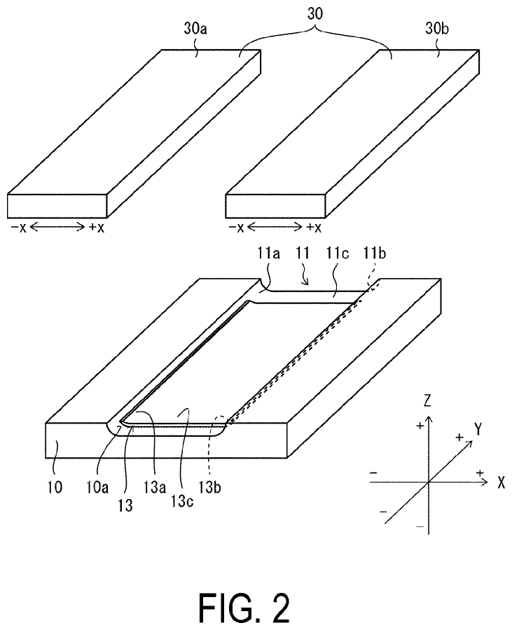

FIG. 1 is a cross-sectional view illustrating a configuration of a laminating device 1 according to a first embodiment of the disclosure. FIG. 2 is a perspective view illustrating a configuration of a mounting stand and a regulating portion of the laminating device 1 according to the first embodiment of the disclosure.

The laminating device 1 is a production device for producing a layered body including a bonded member and a bonding member by bonding the bonding member having a film shape to the bonded member having a surface with a recessed shape. In the present embodiment, it is assumed as an example that the laminating device 1 produces a layered body formed by bonding a protection film (film) 23 to a cover glass (bonded member) 13 used for electronic equipment such as a cellular phone terminal.

The laminating device 1 includes a foundation 2, a mounting stand 10, a holding portion 20, a balloon 5, a balloon supporting portion 3, strut portions 4, a regulating portion 30, regulating portion driving portions 40a, 40b, a controller 50, and a pressure adjusting portion 51.

The mounting stand 10 is a stand on which the cover glass 13 is mounted. A recessed portion 11 corresponding to a shape of the cover glass 13 is formed in a surface (mounting surface) of the mounting stand 10 on which the cover glass 13 is mounted.

As illustrated in FIGS. 1 and 2, a bottom surface 11c of the recessed portion 11 is plane, and edge portions 11a, 11b of the recessed portion 11 on either side of the bottom surface 11c of the recessed portion 11 facing each other have a curved shape. The edge portions 11a, 11b have a shape that gradually rises from the bottom surface 11c side toward respective edges.

A central portion 13c of the cover glass 13 mounted on the recessed portion 11 is also plane. Of four edge portions of the cover glass 13, edge portions 13a, 13b on either side of the central portion 13c facing each other have a curved shape. The edge portions 13a, 13b have a shape that gradually rises from the central portion 13c side toward edges.

As illustrated in FIG. 1, the holding portion 20 holds the protection film 23 such that the protection film 23 faces the cover glass 13 mounted on the mounting stand 10. The holding portion 20 grasps edges of the protection film 23 and extends the protection film 23 away from the cover glass 13.

The balloon 5 is disposed opposite to the cover glass 13 mounted on the mounting stand 10 with respect to the protection film 23 held by the holding portion 20. The balloon 5 is made of an elastic material capable of expanding and contracting, such as rubber. An edge region of the balloon 5 is fixed to the balloon supporting portion 3. For example, the entire edge region may be fixed with screws.

A through hole 3a for introducing a fluid between the balloon supporting portion 3 and the balloon 5 is formed in the balloon supporting portion 3. The through hole 3a is formed in a region of the balloon supporting portion 3 to which the balloon 5 is attached. The balloon supporting portion 3 is supported by the plurality of strut portions 4 to be fixed to the foundation 2.

A tip portion of a pipe 6 is connected to the through hole 3a, and a base portion of the pipe 6 is connected to the pressure adjusting portion 51. The pressure adjusting portion 51 is a pump that supplies a fluid such as a gas. A fluid is introduced between the balloon supporting portion 3 and the balloon 5 from the pressure adjusting portion 51 through the pipe 6 and the through hole 3a to inflate the balloon 5. The fluid supplied from the pressure adjusting portion 51 can be any gas or liquid that can inflate the balloon 5. In the present embodiment, it is assumed that the fluid is air.

As illustrated in FIGS. 1 and 2, the regulating portion 30 includes a first regulating portion 30a and a second regulating portion 30b that face each other and are disposed at a distance.

The first regulating portion 30a and the second regulating portion 30b contact and are attached to the surface of the balloon supporting portion 3 to which the balloon 5 is attached.

The first regulating portion 30a contacts one edge portion 5a of edge portions 5a, 5b facing each other with a central portion 5c therebetween of the balloon 5. The first regulating portion 30a and the balloon supporting portion 3 sandwich the edge portion 5a. The second regulating portion 30b contacts the edge portion 5b. The second regulating portion 30b and the balloon supporting portion 3 sandwich the edge portion 5b.

In this way, the first regulating portion 30a regulates inflation of the edge portion 5a of the balloon 5, and the second regulating portion 30b regulates inflation of the edge portion 5b of the balloon 5.

A length in a longitudinal direction of the first regulating portion 30a and the second regulating portion 30b is longer than or substantially equal to a length in a longitudinal direction of the edge portions 13a, 13b of the cover glass 13.

The first regulating portion 30a and the second regulating portion 30b are disposed away from the surface of the mounting stand 10 in which the recessed portion 11 is formed.

The regulating portion driving portions 40a, 40b hold the regulating portion 30 such that the regulating portion 30 is slidable. The regulating portion driving portion 40a holds the first regulating portion 30a such that the first regulating portion 30a is slidable. The regulating portion driving portion 40b holds the second regulating portion 30b such that the second regulating portion 30b is slidable.

The regulating portion driving portions 40a, 40b each include a motor, and the motor is actuated to slide the first regulating portion 30a or the second regulating portion 30b when receiving an instruction from the controller 50.

As illustrated in FIG. 1, the controller 50 is a computer configured to control drive of the whole laminating device 1. The controller 50 particularly controls drive of the pressure adjusting portion 51 and drive of the regulating portion driving portions 40a, 40b.

In the present embodiment, it is assumed that a normal of the balloon 5, the protection film 23, and the bottom surface 11c of the recessed portion 11 is a Z-axis, and a plane perpendicularly crossing the Z-axis is an XY plane. It is assumed that one axis in the XY plane is an X-axis, and an axis orthogonal to the X-axis is a Y-axis. In the present embodiment, a direction in which the first regulating portion 30a and the second regulating portion 30b are aligned is a positive direction of the X-axis and the opposite direction is a negative direction.

Of the Z-axis, a direction from the balloon 5 toward the protection film 23 and the recessed portion 11 is a positive direction of the Z-axis, and the opposite direction is a negative direction.

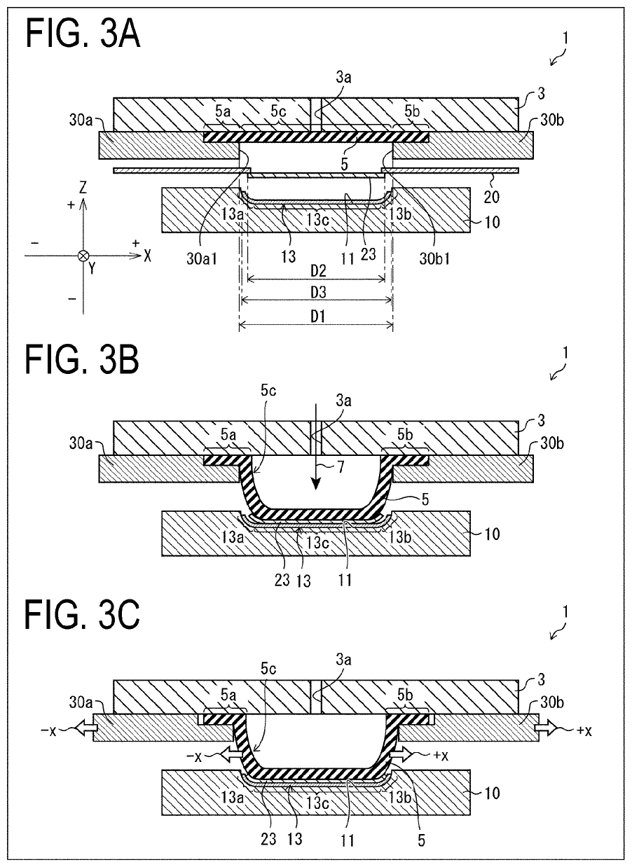

FIG. 3A is a cross-sectional view illustrating a configuration of a main portion of the laminating device 1 according to the first embodiment of the disclosure. FIG. 3B is a diagram illustrating a state where the balloon of the laminating device 1 illustrated in FIG. 3A is inflated. FIG. 3C is a diagram illustrating a state where the first regulating portion 30a and the second regulating portion 30b of the laminating device 1 illustrated in FIG. 3B are sliding.

As illustrated in FIG. 3A, a distance between the first regulating portion 30a and the second regulating portion 30b before the first regulating portion 30a and the second regulating portion 30b slide, namely, a distance between a surface 30a1 of a side surface of the first regulating portion 30a on the side closer to the protection film 23 and a surface 30b1 of a side surface of the second regulating portion 30b on the side closer to the protection film 23 is D1. Note that, the surface 30a1 and the surface 30b1 are surfaces facing each other.

A width in the X-axis direction of the protection film 23 is D2. A width in the X-axis direction of the cover glass 13 is D3.

The distance D1 between the first regulating portion 30a and the second regulating portion 30b before the first regulating portion 30a and the second regulating portion 30b slide may be greater than the width D2 of the protection film 23.

The distance D1 between the first regulating portion 30a and the second regulating portion 30b before the first regulating portion 30a and the second regulating portion 30b slide may be equal to or less than the width D3 of the cover glass 13.

As illustrated in FIGS. 3A and 3B, a fluid 7 is introduced through the through hole 3a formed in the balloon supporting portion 3, fills a space between the balloon supporting portion 3 and the balloon 5, and inflates the balloon 5.

Note that the fluid 7 can be any fluid capable of inflating the balloon 5. A gas such as an air can be used as the fluid 7 as an example.

Herein, the first regulating portion 30a is disposed so as to overlap the edge portion 5a of the balloon 5, and the second regulating portion 30b is disposed so as to overlap the edge portion 5b of the balloon 5.

Particularly in the present embodiment, the first regulating portion 30a contacts the edge portion 5a of the balloon 5 before the balloon 5 is inflated, and the first regulating portion 30a and the balloon supporting portion 3 sandwich the edge portion 5a of the balloon 5, to prevent a flow of the fluid 7 between the edge portion 5a of the balloon 5 and the balloon supporting portion 3. In this way, the first regulating portion 30a regulates inflation of the edge portion 5a, which is a part of the balloon 5.

Furthermore, the second regulating portion 30b contacts the edge portion 5b of the balloon 5 before the balloon 5 is inflated, and the second regulating portion 30b and the balloon supporting portion 3 sandwich the edge portion 5b of the balloon 5, to prevent a flow of the fluid 7 between the edge portion 5b of the balloon 5 and the balloon supporting portion 3. In this way, the second regulating portion 30b regulates inflation of the edge portion 5b, which is a part of the balloon 5.

Thus, as illustrated in FIG. 3B, the central portion 5c, which is a part of the balloon 5, between the edge portion 5a and the edge portion 5b is inflated. As the central portion 5c is inflated, the protection film 23 is pressed and is brought into contact with the cover glass 13 mounted on the mounting stand 10.

The distance D1 between the first regulating portion 30a and the second regulating portion 30b may be set to be less than a width in the X-axis direction of the central portion 13c of the cover glass 13.

An adhesive is applied to a facing surface of the protection film 23 facing the cover glass 13, and the protection film 23 is bonded to the cover glass 13 by contacting the cover glass 13.

The protection film 23 is bonded to the central portion 13c of the cover glass 13 and is not bonded to the edge portions 13a, 13b. Then, the controller 50 (see FIG. 1) stops the pressure adjusting portion 51 to stop a supply of the fluid 7 into a space between the balloon 5 and the balloon supporting portion 3.

Next, as illustrated in FIG. 3C, the regulating portion driving portion 40a (see FIG. 1) slides the first regulating portion 30a so as to reduce a contact area between the edge portion 5a of the balloon 5 and the first regulating portion 30a by an instruction from the controller 50 (see FIG. 1). The regulating portion driving portion 40b (see FIG. 1) slides the second regulating portion 30b so as to reduce a contact area between the edge portion 5b of the balloon 5 and the second regulating portion 30b by an instruction from the controller 50 (see FIG. 1).

The first regulating portion 30a and the second regulating portion 30b slide in a direction away from each other. In the present embodiment, the first regulating portion 30a slides in the X-axis negative direction, and the second regulating portion 30b slides in the X-axis positive direction. In this way, areas of the edge portions 5a, 5b of the balloon 5 where inflation is regulated by the first regulating portion 30a and the second regulating portion 30b are reduced, and an area in the X-axis direction of the inflating central portion 5c increases, which presses the protection film 23 from the central portion toward the edges.

As a result, the protection film 23 is gradually bonded to not only the central portion 13c of the cover glass 13 but also the edge portions 13a, 13b curved so as to rise from the central portion 13c side toward the edge side. In the end, the protection film 23 is bonded to the entire bonded surface of the cover glass 13 having a recessed shape and to which the protection film 23 is bonded.

In this way, even in a case where the surface of the cover glass 13 to which the protection film 23 is bonded is a recessed surface in which the edge portions 13a, 13b gradually rise toward the edges, the protection film 23 can be bonded without air bubbles being formed.

Note that timing at which the first regulating portion 30a and the second regulating portion 30b start sliding may be before the protection film 23 contacts the cover glass 13. The same applies to following embodiments.

### Second Embodiment

A description follows regarding a second embodiment of the present disclosure. Note that, for convenience of description, members having the same function as the members stated in the first embodiment are appended with the same reference signs, and the description thereof is omitted.

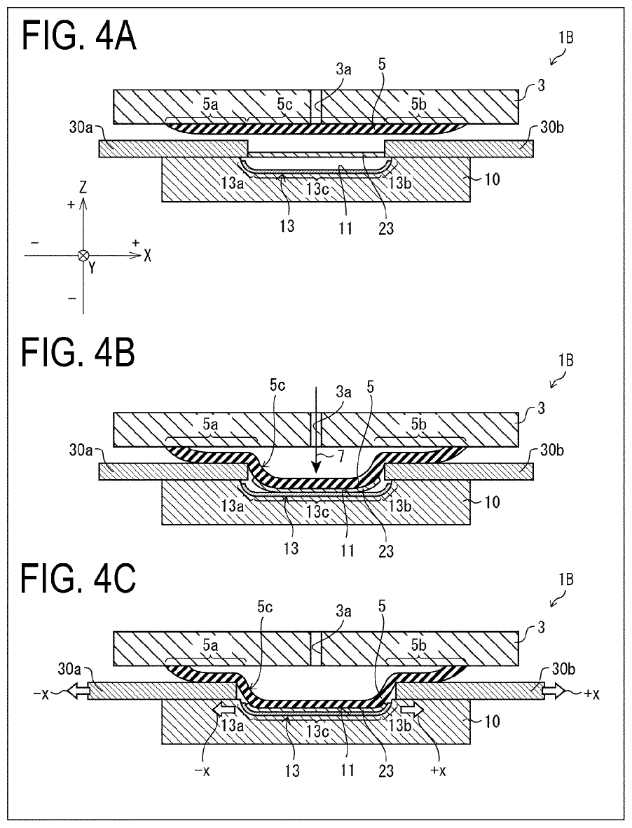

FIG. 4A is a cross-sectional view illustrating a configuration of a main portion of a laminating device 1B according to the second embodiment of the disclosure. FIG. 4B is a diagram illustrating a state where the balloon of the laminating device 1B illustrated in FIG. 4A is inflated. FIG. 4C is a diagram illustrating a state where the first regulating portion 30a and the second regulating portion 30b of the laminating device 1B illustrated in FIG. 4B are sliding.

In comparison with the laminating device 1 illustrated in FIG. 1 or the like, as in the laminating device 1B illustrated FIG. 4A, the first regulating portion 30a and the second regulating portion 30b may contact the mounting stand 10 instead of the balloon supporting portion 3 and may hold the protection film 23. The other configuration of the laminating device 1B is the same as that of the laminating device 1.

In the laminating device 1B, the first regulating portion 30a and the second regulating portion 30b are disposed away from the balloon 5 and the balloon supporting portion 3 and contact the surface of the mounting stand 10 in which the recessed portion 11 is formed. The first regulating portion 30a is disposed to overlap the edge portion 5a of the balloon 5 with the edge portion 5a of the balloon 5 between the balloon supporting portion 3 and the first regulating portion 30a. The second regulating portion 30b is disposed to overlap the edge portion 5b of the balloon 5 with the edge portion 5b of the balloon 5 between the balloon supporting portion 3 and the second regulating portion 30b.

The first regulating portion 30a and the second regulating portion 30b hold the protection film 23 such that the protection film 23 faces the cover glass 13 mounted on the mounting stand 10. The first regulating portion 30a and the second regulating portion 30b grasp the edges of the protection film 23 and extend the protection film 23 away from the cover glass 13.

In the laminating device 1B according to the present embodiment, the first regulating portion 30a and the second regulating portion 30b contact the mounting stand 10, so that a distance between the protection film 23 and the cover glass 13 mounted on the mounting stand 10 is shorter than a distance between the protection film 23 and the cover glass 13 mounted on the mounting stand 10 in the laminating device 1 (see FIG. 1 or the like).

As illustrated in FIGS. 4A and 4B, the fluid 7 is introduced through the through hole 3a formed in the balloon supporting portion 3, fills a space between the balloon supporting portion 3 and the balloon 5, and inflates the balloon 5.

In the present embodiment, the first regulating portion 30a and the second regulating portion 30b are disposed away from the balloon 5. Thus, the edge portion 5a of the balloon 5 is inflated to the extent that the edge portion 5a contacts the first regulating portion 30a, but the first regulating portion 30a regulates further inflation of the edge portion 5a. In this way, the first regulating portion 30a regulates inflation of the edge portion 5a of the balloon 5 in the process of inflation of the balloon 5.

Furthermore, the edge portion 5b of the balloon 5 is inflated to the extent that the edge portion 5b contacts the second regulating portion 30b, but the second regulating portion 30b regulates further inflation of the edge portion 5b. In this way, the second regulating portion 30b regulates inflation of the edge portion 5b of the balloon 5 in the process of inflation of the balloon 5.

Thus, as illustrated in FIG. 4B, the central portion 5c, which is a part of the balloon 5, between the edge portion 5a and the edge portion 5b is inflated more than the edge portions 5a, 5b. As the central portion 5c is inflated, the protection film 23 is pressed, is brought into contact with the cover glass 13 mounted on the mounting stand 10, and is bonded thereto. The protection film 23 is bonded to the central portion 13c of the cover glass 13 and is not bonded to the edge portions 13a, 13b. Then, the controller 50 (see FIG. 1) stops the pressure adjusting portion 51 to stop a supply of the fluid 7 into a space between the balloon 5 and the balloon supporting portion 3.

Next, as illustrated in FIG. 4C, the regulating portion driving portion 40a (see FIG. 1) slides the first regulating portion 30a so as to reduce a contact area between the edge portion 5a of the balloon 5 and the first regulating portion 30a by an instruction from the controller 50 (see FIG. 1). The regulating portion driving portion 40b slides the second regulating portion 30b so as to reduce a contact area between the edge portion 5b of the balloon 5 and the second regulating portion 30b by an instruction from the controller 50.

The first regulating portion 30a and the second regulating portion 30b slide in a direction away from each other. In the present embodiment, the first regulating portion 30a slides in the X-axis negative direction, and the second regulating portion 30b slides in the X-axis positive direction. In this way, areas of the edge portions 5a, 5b of the balloon 5 where inflation is regulated by the first regulating portion 30a and the second regulating portion 30b are reduced, and an area in the X-axis direction of the inflating central portion 5c increases, which presses the protection film 23 from the central portion toward the edges.

As a result, the protection film 23 is gradually bonded to not only the central portion 13c of the cover glass 13 but also the edge portions 13a, 13b curved so as to rise from the central portion 13c side toward the edge side. In the end, the protection film 23 is bonded to the entire bonded surface of the cover glass 13 having a recessed shape and to which the protection film 23 is bonded.

In the present embodiment, the first regulating portion 30a and the second regulating portion 30b contact the mounting stand 10, and are thus closer to the cover glass 13 than the first regulating portion and the second regulating portion disposed at a distance from the mounting stand. Thus, a position and an area of inflation of the balloon 5 can be easily controlled. In this way, the laminating device 1B can bond the protection film 23 to the cover glass 13 while accurately controlling inflation of the balloon 5. Accordingly, the protection film 23 can be bonded to the cover glass 13 while air bubbles are further prevented from being formed.

### Third Embodiment

A description follows regarding a third embodiment of the disclosure. Note that, for convenience of description, members having the same function as the members stated in the first and second embodiments are appended with the same reference signs, and the description thereof is omitted.

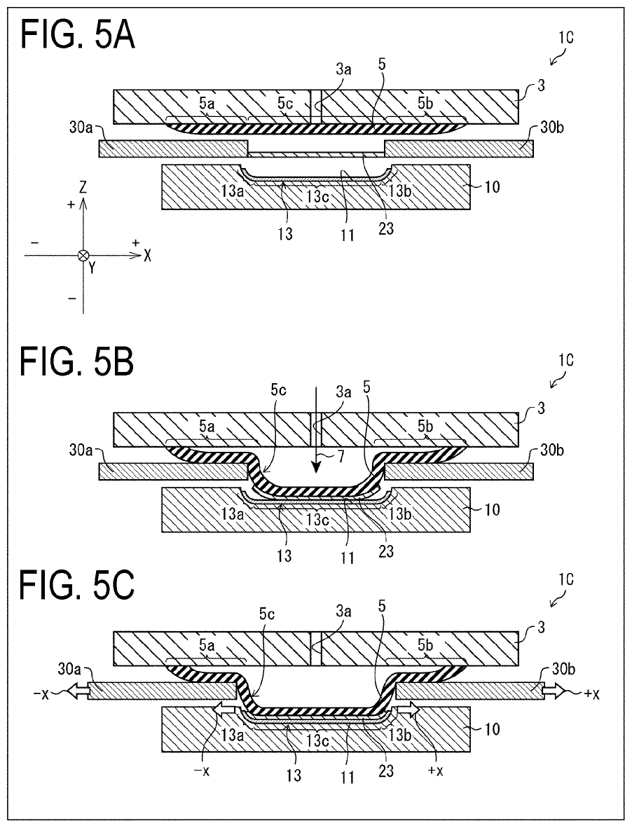

FIG. 5A is a cross-sectional view illustrating a configuration of a main portion of a laminating device 1C according to the third embodiment of the disclosure. FIG. 5B is a diagram illustrating the state where a balloon of the laminating device 1C illustrated in FIG. 5A is inflated. FIG. 5C is a diagram illustrating a state where the first regulating portion 30a and the second regulating portion 30b of the laminating device 1C illustrated in FIG. 5B are sliding.

In comparison with the laminating device 1 illustrated in FIG. 1 or the like, as in the laminating device 1C illustrated FIG. 5A, the first regulating portion 30a and the second regulating portion 30b may be disposed away from the balloon supporting portion 3 and the mounting stand 10 and may hold the protection film 23. The other configuration of the laminating device 1C is the same as that of the laminating device 1.

In the laminating device 1C, the first regulating portion 30a and the second regulating portion 30b are disposed away from the balloon 5 and the balloon supporting portion 3, are also disposed away from the mounting stand 10, and are disposed between the balloon 5 and the balloon supporting portion 3, and the mounting stand 10.

The first regulating portion 30a is disposed to overlap the edge portion 5a of the balloon 5 with the edge portion 5a of the balloon 5 between the balloon supporting portion 3 and the first regulating portion 30a. The second regulating portion 30b is disposed to overlap the edge portion 5b of the balloon 5 with the edge portion 5b of the balloon 5 between the balloon supporting portion 3 and the second regulating portion 30b.

The first regulating portion 30a and the second regulating portion 30b hold the protection film 23 such that the protection film 23 faces the cover glass 13 mounted on the mounting stand 10. The first regulating portion 30a and the second regulating portion 30b grasp the edges of the protection film 23 and extend the protection film 23 away from the cover glass 13.

In the laminating device 1C according to the present embodiment, the first regulating portion 30a and the second regulating portion 30b are disposed away from the balloon supporting portion 3 and the mounting stand 10, so that a distance between the protection film 23 and the cover glass 13 mounted on the mounting stand 10 is shorter than a distance between the protection film 23 and the cover glass 13 mounted on the mounting stand 10 in the laminating device 1 (see FIG. 1 or the like) and is longer than a distance between the protection film 23 and the cover glass 13 mounted on the mounting stand 10 in the laminating device 1B (see FIG. 4 or the like).

As illustrated in FIGS. 5A and 5B, the fluid 7 is introduced through the through hole 3a formed in the balloon supporting portion 3, fills a space between the balloon supporting portion 3 and the balloon 5, and inflates the balloon 5.

In the present embodiment, the first regulating portion 30a and the second regulating portion 30b are disposed away from the balloon 5. Thus, the edge portion 5a of the balloon 5 is inflated to the extent that the edge portion 5a contacts the first regulating portion 30a, but the first regulating portion 30a regulates further inflation of the edge portion 5a. In this way, the first regulating portion 30a regulates inflation of the edge portion 5a of the balloon 5 in the process of inflation of the balloon 5.

Furthermore, the edge portion 5b of the balloon 5 is inflated to the extent that the edge portion 5b contacts the second regulating portion 30b, but the second regulating portion 30b regulates further inflation of the edge portion 5b. In this way, the second regulating portion 30b regulates inflation of the edge portion 5b of the balloon 5 in the process of inflation of the balloon 5.

A distance between the first and second regulating portions 30a, 30b and the balloon supporting portion 3 in the laminating device 1C according to the present embodiment is shorter than a distance between the first and second regulating portions 30a, 30b and the balloon supporting portion 3 in the laminating device 1B (see FIG. 4). Thus, the extent that the edge portions 5a, 5b are inflated in the laminating device 1C is less than that in the laminating device 1B.

Then, as illustrated in FIG. 5B, the central portion 5c, which is a part of the balloon 5, between the edge portion 5a and the edge portion 5b is inflated more than the edge portions 5a, 5b. As the central portion 5c is inflated, the protection film 23 is pressed, is brought into contact with the cover glass 13 mounted on the mounting stand 10, and is bonded thereto. The protection film 23 is bonded to the central portion 13c of the cover glass 13 and is not bonded to the edge portions 13a, 13b. Then, the controller 50 (see FIG. 1) stops the pressure adjusting portion 51 to stop a supply of the fluid 7 into a space between the balloon 5 and the balloon supporting portion 3.

Next, as illustrated in FIG. 5C, the regulating portion driving portion 40a (see FIG. 1) slides the first regulating portion 30a so as to reduce a contact area between the edge portion 5a of the balloon 5 and the first regulating portion 30a by an instruction from the controller 50 (see FIG. 1). The regulating portion driving portion 40b slides the second regulating portion 30b so as to reduce a contact area between the edge portion 5b of the balloon 5 and the second regulating portion 30b by an instruction from the controller 50.

The first regulating portion 30a and the second regulating portion 30b slide in a direction away from each other. In the present embodiment, the first regulating portion 30a slides in the X-axis negative direction, and the second regulating portion 30b slides in the X-axis positive direction. In this way, areas of the edge portions 5a, 5b of the balloon 5 where inflation is regulated by the first regulating portion 30a and the second regulating portion 30b are reduced, and an area in the X-axis direction of the inflating central portion 5c increases, which presses the protection film 23 from the central portion toward the edges.

As a result, the protection film 23 is gradually bonded to not only the central portion 13c of the cover glass 13 but also the edge portions 13a, 13b curved so as to rise from the central portion 13c side toward the edge side. In the end, the protection film 23 is bonded to the entire bonded surface of the cover glass 13 having a recessed shape and to which the protection film 23 is bonded.

In the present embodiment, the first regulating portion 30a and the second regulating portion 30b are disposed between the balloon 5 and the balloon supporting portion 3, and the mounting stand 10 and are thus closer to the cover glass 13 than the first regulating portion and the second regulating portion that are disposed at a distance from the mounting stand and that contact the balloon and the balloon supporting portion. Thus, a position and an area of inflation of the balloon 5 can be easily controlled. In this way, the laminating device 1C can also bond the protection film 23 to the cover glass 13 while accurately controlling inflation of the balloon 5. Accordingly, the protection film 23 can be bonded to the cover glass 13 while air bubbles are further prevented from being formed.

### Fourth Embodiment

A description follows regarding a fourth embodiment of the disclosure. Note that, for convenience of description, members having the same function as the members stated in the first to third embodiments are appended with the same reference signs, and the description thereof is omitted.

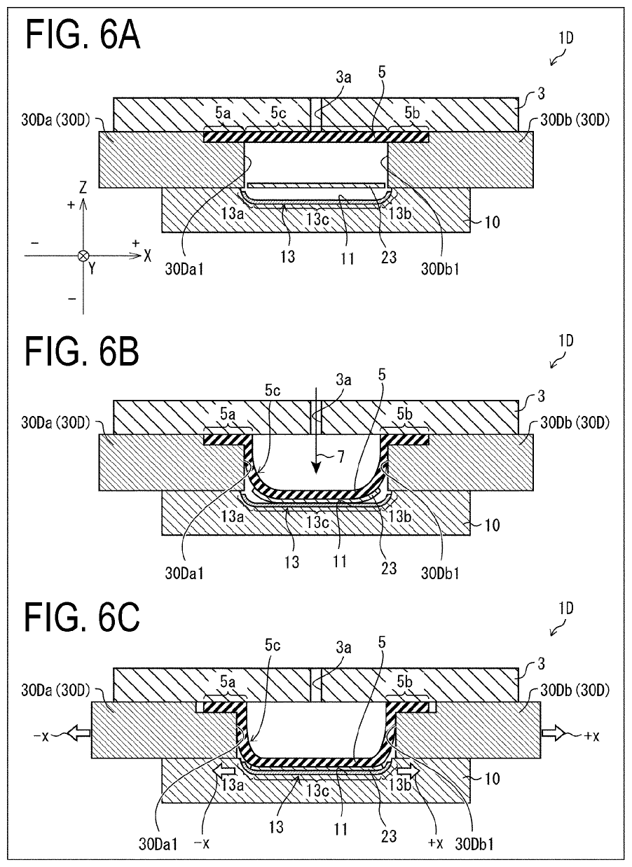

FIG. 6A is a cross-sectional view illustrating a configuration of a main portion of a laminating device 1D according to the fourth embodiment of the disclosure. FIG. 6B is a diagram illustrating a state where the balloon 5 of the laminating device 1D illustrated in FIG. 6A is inflated. FIG. 6C is a diagram illustrating a state where a first regulating portion 30Da and a second regulating portion 30Db of the laminating device 1D illustrated in FIG. 6B are sliding.

The laminating device 1D illustrated in FIG. 6A includes the first regulating portion 30Da and the second regulating portion 30Db instead of the first regulating portion 30a and the second regulating portion 30b included in the laminating device 1 illustrated in FIG. 1 or the like, and the first regulating portion 30Da and the second regulating portion 30Db hold the protection film 23. The other configuration of the laminating device 1D is the same as that of the laminating device 1.

The first regulating portion 30Da contacts the edge portion 5a of the balloon 5. The first regulating portion 30Da and the balloon supporting portion 3 sandwich the edge portion 5a. The first regulating portion 30Da also contacts the surface of the mounting stand 10 in which the recessed portion 11 is formed.

The second regulating portion 30Db contacts the edge portion 5b of the balloon 5. The second regulating portion 30Db and the balloon supporting portion 3 sandwich the edge portion 5b. The second regulating portion 30Db also contacts the surface of the mounting stand 10 in which the recessed portion 11 is formed.

The first regulating portion 30Da and the second regulating portion 30Db hold the protection film 23 such that the protection film 23 faces the cover glass 13 mounted on the mounting stand 10. The first regulating portion 30Da and the second regulating portion 30Db grasp the edges of the protection film 23 and extend the protection film 23 away from the cover glass 13.

In the laminating device 1D according to the present embodiment, the first regulating portion 30Da and the second regulating portion 30Db have a thickness thick enough to fill a gap between the balloon supporting portion 3 and the mounting stand 10.

A facing surface 30Da1 of the first regulating portion 30Da facing the second regulating portion 30Db and a facing surface 30Db1 of the second regulating portion 30Db facing the first regulating portion 30Da are disposed from the central portion 5c of the balloon 5 to the recessed portion 11 of the mounting stand 10 without a gap.

As illustrated in FIGS. 6A and 6B, the fluid 7 is introduced through the through hole 3a formed in the balloon supporting portion 3, fills a space between the balloon supporting portion 3 and the balloon 5, and inflates the balloon 5.

In the present embodiment, the first regulating portion 30Da and the balloon supporting portion 3 sandwich the edge portion 5a of the balloon 5, to prevent a flow of the fluid 7 between the edge portion 5a of the balloon 5 and the balloon supporting portion 3. In this way, the first regulating portion 30Da regulates inflation of the edge portion 5a, which is a part of the balloon 5.

Furthermore, the second regulating portion 30Db and the balloon supporting portion 3 sandwich the edge portion 5b of the balloon 5, to prevent a flow of the fluid 7 between the edge portion 5b of the balloon 5 and the balloon supporting portion 3. In this way, the second regulating portion 30Db regulates inflation of the edge portion 5b, which is a part of the balloon 5.

Then, as illustrated in FIG. 6B, the central portion 5c, which is a part of the balloon 5, between the edge portion 5a and the edge portion 5b is inflated. As the central portion 5c is inflated, the protection film 23 is pressed, is brought into contact with the cover glass 13 mounted on the mounting stand 10, and is bonded thereto.

The protection film 23 is bonded to the central portion 13c of the cover glass 13 and is not bonded to the edge portions 13a, 13b. Then, the controller 50 (see FIG. 1) stops the pressure adjusting portion 51 to stop a supply of the fluid 7 into a space between the balloon 5 and the balloon supporting portion 3.

Herein, the facing surface 30Da1 of the first regulating portion 30Da facing the second regulating portion 30Db and the facing surface 30Db1 of the second regulating portion 30Db facing the first regulating portion 30Da are disposed from the central portion 5c of the balloon 5 to the recessed portion 11 of the mounting stand 10 without a gap. Thus, the central portion 5c of the balloon 5 is inflated along the facing surface 30Da1 and the facing surface 30Db1, and the protection film 23 is pressed and is brought into contact with the cover glass 13 mounted on the mounting stand 10.

Thus, a shape of the central portion 5c of the balloon 5 is easily controlled, and the protection film 23 can be more reliably bonded to the entire surface of the central portion 13c of the cover glass 13 before the protection film 23 contacts the edge portions 13a, 13b of the cover glass 13.

The protection film 23 is bonded to the entire surface of the central portion 13c of the cover glass 13. Next, as illustrated in FIG. 6C, the regulating portion driving portion 40a (see FIG. 1) slides the first regulating portion 30Da so as to reduce a contact area between the edge portion 5a of the balloon 5 and the first regulating portion 30Da by an instruction from the controller 50 (see FIG. 1). The regulating portion driving portion 40b slides the second regulating portion 30Db so as to reduce a contact area between the edge portion 5b of the balloon 5 and the second regulating portion 30Db by an instruction from the controller 50.

The first regulating portion 30Da and the second regulating portion 30Db slide in a direction away from each other. In the present embodiment, the first regulating portion 30Da slides in the X-axis negative direction, and the second regulating portion 30Db slides in the X-axis positive direction. In this way, areas of the edge portions 5a, 5b of the balloon 5 where inflation is regulated by the first regulating portion 30Da and the second regulating portion 30Db are reduced, and an area in the X-axis direction of the inflating central portion 5c increases, which presses the protection film 23 from the central portion toward the edges.

As a result, the protection film 23 is gradually bonded to not only the central portion 13c of the cover glass 13 but also the edge portions 13a, 13b curved so as to rise from the central portion 13c side toward the edge side. In the end, the protection film 23 is bonded to the entire bonded surface of the cover glass 13 having a recessed shape and to which the protection film 23 is bonded.

According to the present embodiment, the first regulating portion 30Da and the second regulating portion 30Db have a thickness thick enough to contact both of the balloon 5 and the balloon supporting portion 3, and the mounting stand 10. Thus, rigidity of the first regulating portion 30Da and the second regulating portion 30Db can be increased more than that of the first regulating portion and the second regulating portion disposed away from at least one of the balloon and the balloon supporting portion, and the mounting stand. In this way, a shape of the first regulating portion 30Da and the second regulating portion 30Db is hardly changed by inflation of the balloon 5, and the protection film 23 can be bonded to the cover glass 13 while inflation of the balloon 5 is accurately controlled.

Furthermore, the first regulating portion 30Da and the second regulating portion 30Db are closer to the cover glass 13 than the first regulating portion and the second regulating portion disposed at a distance from the mounting stand. Also from this regard, the protection film 23 can be bonded to the cover glass 13 while inflation of the balloon 5 is accurately controlled.

Accordingly, the protection film 23 can be bonded to the cover glass 13 while air bubbles are further prevented from being formed.

### Fifth Embodiment

A description follows regarding a fifth embodiment of the disclosure. Note that, for convenience of description, members having the same function as the members stated in the first to fourth embodiments are appended with the same reference signs, and the description thereof is omitted.

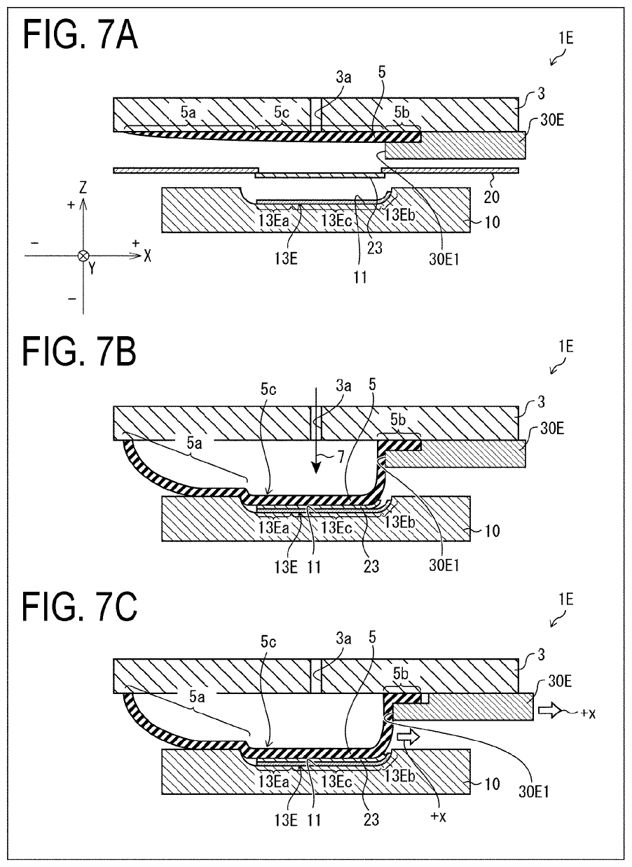

FIG. 7A is a cross-sectional view illustrating a configuration of a main portion of a laminating device 1E according to the fifth embodiment of the disclosure. FIG. 7B is a diagram illustrating a state where the balloon 5 of the laminating device 1E illustrated in FIG. 7A is inflated. FIG. 7C is a diagram illustrating a state where a regulating portion 30E of the laminating device 1E illustrated in FIG. 7B is sliding.

The laminating device 1E illustrated in FIG. 7A includes one regulating portion 30E instead of the first regulating portion 30a and the second regulating portion 30b included in the laminating device 1 illustrated in FIG. 1 or the like. Furthermore, the laminating device 1E includes only the regulating portion driving portion 40b of the regulating portion driving portions 40a, 40b (see FIG. 1). The regulating portion driving portion 40b slides the regulating portion 30E in the X-axis direction.

A central portion 13Ec of a cover glass 13E to which the protection film 23 is bonded by the laminating device 1E is plane. Of four edge portions of the cover glass 13E, one edge portion 13Ea of edge portions 13Ea, 13Eb on either side of the central portion 13Ec facing each other is plane while only the other edge portion 13Eb has a curved shape. The edge portion 13Eb has such a shape that gradually rises from the central portion 13Ec side toward an edge.

The other configuration of the laminating device 1E is the same as that of the laminating device 1 (see FIG. 1 or the like).

The regulating portion 30E contacts the edge portion 5b of the balloon 5. The regulating portion 30E and the balloon supporting portion 3 sandwich the edge portion 5b. The regulating portion 30E is disposed away from the surface of the mounting stand 10 in which the recessed portion 11 is formed.

As illustrated in FIGS. 7A and 7B, the fluid 7 is introduced through the through hole 3a formed in the balloon supporting portion 3, fills a space between the balloon supporting portion 3 and the balloon 5, and inflates the balloon 5.

However, the regulating portion 30E and the balloon supporting portion 3 sandwich the edge portion 5b of the balloon 5, to prevent a flow of the fluid 7 between the edge portion 5b of the balloon 5 and the balloon supporting portion 3. In this way, the regulating portion 30E regulates inflation of the edge portion 5b, which is a part of the balloon 5.

Thus, as illustrated in FIG. 7B, the edge portion 5a and the central portion 5c, which are a part of the balloon 5, are inflated. As the edge portion 5a and the central portion 5c are inflated, the protection film 23 is pressed, is brought into contact with the cover glass 13E mounted on the mounting stand 10, and is bonded thereto. The protection film 23 is bonded to the edge portion 13Ea and the central portion 13Ec of the cover glass 13E and is not bonded to the edge portion 13Eb.

Note that, at this time, a surface 30E1 of a side surface of the regulating portion 30E on the side closer to the protection film 23 is preferably disposed above the cover glass 13E and is preferably disposed in a position overlapping the edge portion 13Eb or the central portion 13Ec. In this way, as the balloon 5 is inflated, the protection film 23 can be gradually bonded to the central portion 13Ec from the center to the end.

Then, the controller 50 (see FIG. 1) stops the pressure adjusting portion 51 to stop a supply of the fluid 7 into a space between the balloon 5 and the balloon supporting portion 3.

Next, as illustrated in FIG. 7C, the regulating portion driving portion 40b (see FIG. 1) slides the regulating portion 30E so as to reduce a contact area between the edge portion 5b of the balloon 5 and the regulating portion 30E by an instruction from the controller 50 (see FIG. 1).

The regulating portion 30E slides in an outward direction (X-axis positive direction). In this way, an area of the edge portion 5b of the balloon 5 where inflation is regulated by the regulating portion 30E is reduced, and an area in the X-axis direction of the inflating central portion 5c increases, which presses the protection film 23 from the central portion toward the edge.

As a result, the protection film 23 is gradually bonded to not only the edge portion 13Ea and the central portion 13Ec of the cover glass 13E but also the edge portion 13Eb curved so as to rise from the central portion 13Ec side toward the edge side. In the end, the protection film 23 is bonded to the entire bonded surface of the cover glass 13E that includes only one edge portion 13Eb of the four edge portions having a recessed shape and to which the protection film 23 is bonded.

According to the present embodiment, the protection film 23 can also be bonded to the cover glass 13E whose only one side of the edges facing each other is curved while air bubbles are prevented from being formed.

### Sixth Embodiment

A description follows regarding a sixth embodiment of the disclosure. Note that, for convenience of description, members having the same function as the members stated in the first to fifth embodiments are appended with the same reference signs, and the description thereof is omitted.

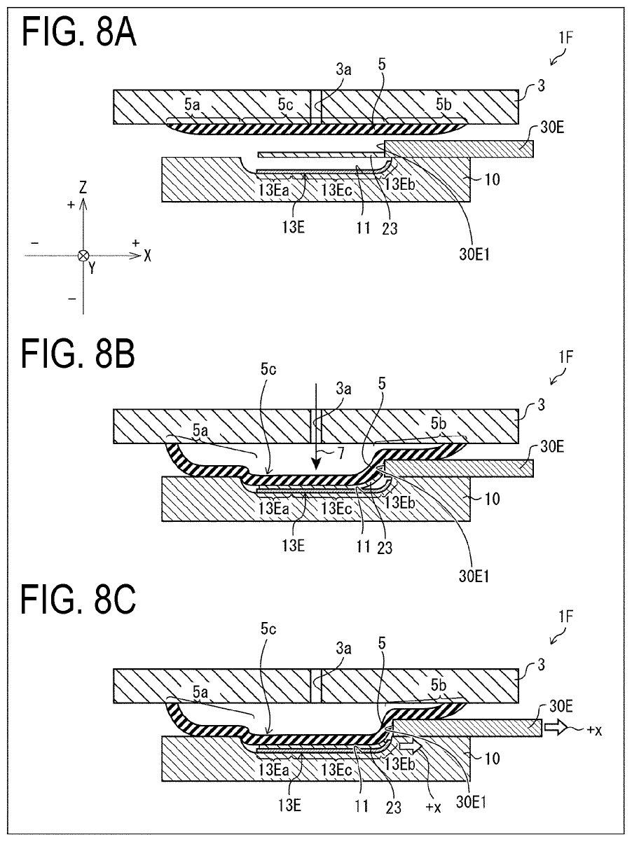

FIG. 8A is a cross-sectional view illustrating a configuration of a main portion of a laminating device 1F according to the sixth embodiment of the disclosure. FIG. 8B is a diagram illustrating a state where the balloon 5 of the laminating device 1F illustrated in FIG. 8A is inflated. FIG. 8C is a diagram illustrating a state where the regulating portion 30E of the laminating device 1F illustrated in FIG. 8B is sliding.

In comparison with the laminating device 1E illustrated in FIG. 7, as in the laminating device 1F illustrated FIG. 8A, the regulating portion 30E may contact the mounting stand 10 instead of the balloon supporting portion 3 and may hold the protection film 23. The other configuration of the laminating device 1F is the same as that of the laminating device 1E. Note that the protection film 23 is bonded to the cover glass 13E also in the laminating device 1F.

In the laminating device 1F, the regulating portion 30E is disposed away from the balloon 5 and the balloon supporting portion 3 and contacts the surface of the mounting stand 10 in which the recessed portion 11 is formed. The regulating portion 30E is disposed to overlap the edge portion 5b of the balloon 5 with the edge portion 5b of the balloon 5 between the balloon supporting portion 3 and the regulating portion 30E.

The regulating portion 30E holds the protection film 23 such that the protection film 23 faces the cover glass 13 mounted on the mounting stand 10. The regulating portion 30E grasps an edge of the protection film 23 and extends the protection film 23 away from the cover glass 13.

In the laminating device 1 according to the present embodiment, the regulating portion 30E contacts the mounting stand 10, so that a distance between the protection film 23 and the cover glass 13 mounted on the mounting stand 10 is shorter than a distance between the protection film 23 and the cover glass 13 mounted on the mounting stand 10 in the laminating device 1E (see FIG. 7 or the like). Thus, the balloon 5 can be easily controlled.

As illustrated in FIGS. 8A and 8B, the fluid 7 is introduced through the through hole 3a formed in the balloon supporting portion 3, fills a space between the balloon supporting portion 3 and the balloon 5, and inflates the balloon 5.

In the present embodiment, the regulating portion 30E is disposed away from the balloon 5. Thus, the edge portion 5b of the balloon 5 is inflated to the extent that the edge portion 5b contacts the regulating portion 30E, but the regulating portion 30E regulates further inflation of the edge portion 5b.

Thus, as illustrated in FIG. 8B, the central portion 5c, which is a part of the balloon 5, between the edge portion 5a and the edge portion 5b is inflated more than the edge portion 5b. As the edge portion 5b and the central portion 5c are inflated, the protection film 23 is pressed, is brought into contact with the cover glass 13 mounted on the mounting stand 10, and is bonded thereto. The protection film 23 is bonded to the edge portion 13Ea and the central portion 13Ec of the cover glass 13E and is not bonded to the edge portion 13Eb.

Note that, at this time, the surface 30E1 of the side surface of the regulating portion 30E on the side closer to the protection film 23 is preferably disposed above the cover glass 13E and is preferably disposed in a position overlapping the edge portion 13Eb or the central portion 13Ec. In this way, as the balloon 5 is inflated, the protection film 23 can be gradually bonded to the central portion 13Ec from the center to the end.

Then, the controller 50 (see FIG. 1) stops the pressure adjusting portion 51 to stop a supply of the fluid 7 into a space between the balloon 5 and the balloon supporting portion 3.

Next, as illustrated in FIG. 8C, the regulating portion driving portion 40b (see FIG. 1) slides the regulating portion 30E so as to reduce a contact area between the edge portion 5b of the balloon 5 and the regulating portion 30E by an instruction from the controller 50 (see FIG. 1).

The regulating portion 30E slides in an outward direction (X-axis positive direction). In this way, an area of the edge portion 5b of the balloon 5 where inflation is regulated by the regulating portion 30E is reduced, and an area in the X-axis direction of the inflating central portion 5c increases, which presses the protection film 23 from the central portion toward the edge.

As a result, the protection film 23 is gradually bonded to not only the edge portion 13Ea and the central portion 13Ec of the cover glass 13E but also the edge portion 13Eb curved so as to rise from the central portion 13Ec side toward the edge side. In the end, the protection film 23 is bonded to the entire bonded surface of the cover glass 13E that includes only one edge portion 13Eb of the four edge portions having a recessed shape and to which the protection film 23 is bonded.

According to the present embodiment, the protection film 23 can also be bonded to the cover glass 13E whose only one side of the edges facing each other is curved while air bubbles are prevented from being formed.

### Seventh Embodiment

A description follows regarding a seventh embodiment of the disclosure. Note that, for convenience of description, members having the same function as the members stated in the first to sixth embodiments are appended with the same reference signs, and the description thereof is omitted.

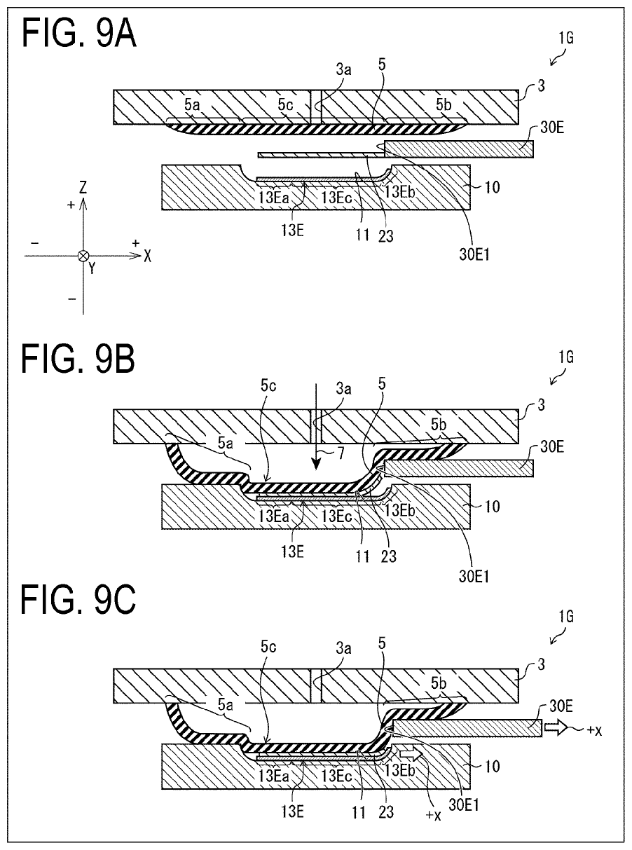

FIG. 9A is a cross-sectional view illustrating a configuration of a main portion of a laminating device 1G according to the seventh embodiment of the disclosure. FIG. 9B is a diagram illustrating a state where the balloon 5 of the laminating device 1G illustrated in FIG. 9A is inflated. FIG. 9C is a diagram illustrating a state where the regulating portion 30E of the laminating device 1G illustrated in FIG. 9B is sliding.

In comparison with the laminating device 1E illustrated in FIG. 7, as in the laminating device 1G illustrated FIG. 9A, the regulating portion 30E may be disposed away from the balloon supporting portion 3 and the mounting stand 10 and may hold the protection film 23. The other configuration of the laminating device 1G is the same as that of the laminating device 1E. Note that the protection film 23 is bonded to the cover glass 13E also in the laminating device 1G.

In the laminating device 1G, the regulating portion 30E is disposed away from the balloon 5 and the balloon supporting portion 3, is also disposed away from the mounting stand 10, and is disposed between the balloon 5 and the balloon supporting portion 3, and the mounting stand 10.

The regulating portion 30E is disposed to overlap the edge portion 5b of the balloon 5 with the edge portion 5b of the balloon 5 between the balloon supporting portion 3 and the regulating portion 30E.

The regulating portion 30E holds the protection film 23 such that the protection film 23 faces the cover glass 13E mounted on the mounting stand 10. The regulating portion 30E grasps an edge of the protection film 23 and extends the protection film 23 away from the cover glass 13E.

In the laminating device 1F according to the present embodiment, the regulating portion 30E is disposed away from the balloon supporting portion 3 and the mounting stand 10, so that a distance between the protection film 23 and the cover glass 13E mounted on the mounting stand 10 is shorter than a distance between the protection film 23 and the cover glass 13E mounted on the mounting stand 10 in the laminating device 1E (see FIG. 7 or the like) and is longer than a distance between the protection film 23 and the cover glass 13E mounted on the mounting stand 10 in the laminating device 1F (see FIG. 8 or the like).

As illustrated in FIGS. 9A and 9B, the fluid 7 is introduced through the through hole 3a formed in the balloon supporting portion 3, fills a space between the balloon supporting portion 3 and the balloon 5, and inflates the balloon 5.

In the present embodiment, the regulating portion 30E is disposed away from the balloon 5. Thus, the edge portion 5b of the balloon 5 is inflated to the extent that the edge portion 5b contacts the regulating portion 30E, but the regulating portion 30E regulates further inflation of the edge portion 5b.

A distance between the regulating portion 30E and the balloon supporting portion 3 in the laminating device 1G according to the present embodiment is shorter than a distance between the regulating portion 30E and the balloon supporting portion 3 in the laminating device 1F (see FIG. 8). Thus, the extent that the edge portion 5b is inflated in the laminating device 1G is less than that in the laminating device 1F.

Then, as illustrated in FIG. 9B, the central portion 5c, which is a part of the balloon 5, between the edge portion 5a and the edge portion 5b is inflated more than the edge portion 5b. As the central portion 5c is inflated, the protection film 23 is pressed, is brought into contact with the cover glass 13 mounted on the mounting stand 10, and is bonded thereto. The protection film 23 is bonded to the edge portion 13Ea and the central portion 13Ec of the cover glass 13E and is not bonded to the edge portion 13Eb.

Note that, at this time, the surface 30E1 of the side surface of the regulating portion 30E is preferably disposed above the cover glass 13E and is preferably disposed in a position overlapping the edge portion 13Eb or the central portion 13Ec. In this way, as the balloon 5 is inflated, the protection film 23 can be gradually bonded to the central portion 13Ec from the center to the end.

Then, the controller 50 (see FIG. 1) stops the pressure adjusting portion 51 to stop a supply of the fluid 7 into a space between the balloon 5 and the balloon supporting portion 3.

Next, as illustrated in FIG. 9C, the regulating portion driving portion 40b (see FIG. 1) slides the regulating portion 30E so as to reduce a contact area between the edge portion 5b of the balloon 5 and the regulating portion 30E by an instruction from the controller 50 (see FIG. 1).

The regulating portion 30E slides in an outward direction (X-axis positive direction). In this way, an area of the edge portion 5b of the balloon 5 where inflation is regulated by the regulating portion 30E is reduced, and an area in the X-axis direction of the inflating central portion 5c increases, which presses the protection film 23 from the central portion toward the edge.

As a result, the protection film 23 is gradually bonded to not only the edge portion 13Ea and the central portion 13Ec of the cover glass 13E but also the edge portion 13Eb curved so as to rise from the central portion 13Ec side toward the edge side. In the end, the protection film 23 is bonded to the entire bonded surface of the cover glass 13E that includes only one edge portion 13Eb of the four edge portions having a recessed shape and to which the protection film 23 is bonded.

According to the present embodiment, the protection film 23 can also be bonded to the cover glass 13E whose only one side of the edges facing each other is curved while air bubbles are prevented from being formed.

### Eighth Embodiment

A description follows regarding an eighth embodiment of the disclosure. Note that, for convenience of description, members having the same function as the members stated in the first to seventh embodiments are appended with the same reference signs, and the description thereof is omitted.

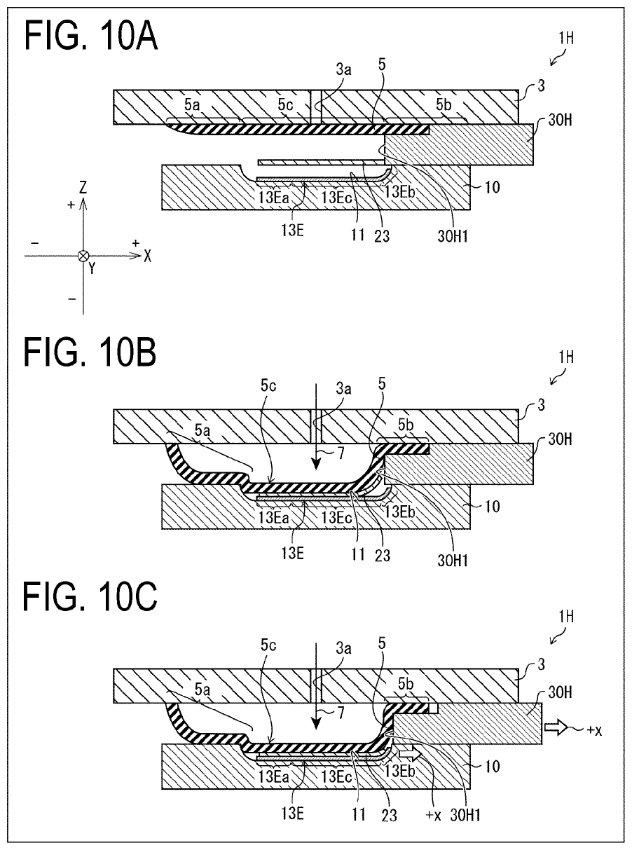

FIG. 10A is a cross-sectional view illustrating a configuration of a main portion of a laminating device 1H according to the eighth embodiment of the disclosure. FIG. 10B is a diagram illustrating a state where the balloon 5 of the laminating device 1H illustrated in FIG. 10A is inflated. FIG. 10C is a diagram illustrating a state where a regulating portion 30H of the laminating device 1H illustrated in FIG. 10B is sliding.

The laminating device 1H illustrated in FIG. 10A includes the regulating portion 30H instead of the regulating portion 30E included in the laminating device 1E illustrated in FIG. 7 and the regulating portion 30H holds the protection film 23. The other configuration of the laminating device 1H is the same as that of the laminating device 1E. Note that the protection film 23 is bonded to the cover glass 13E also in the laminating device 1H.

The regulating portion 30H contacts the edge portion 5b of the balloon 5. The regulating portion 30H and the balloon supporting portion 3 sandwich the edge portion 5b. The regulating portion 30H also contacts the surface of the mounting stand 10 in which the recessed portion 11 is formed.

The regulating portion 30H holds the protection film 23 such that the protection film 23 faces the cover glass 13E mounted on the mounting stand 10. The regulating portion 30H grasps an edge of the protection film 23 and extends the protection film 23 away from the cover glass 13E.

In the laminating device 1H according to the present embodiment, the regulating portion 30H has a thickness thick enough to fill a gap between the balloon supporting portion 3 and the mounting stand 10.

A surface 30H1 of the regulating portion 30H on the side on which the protection film 23 is disposed is disposed from the central portion 5c of the balloon 5 to the recessed portion 11 of the mounting stand 10 without a gap.

As illustrated in FIGS. 10A and 10B, the fluid 7 is introduced through the through hole 3a formed in the balloon supporting portion 3, fills a space between the balloon supporting portion 3 and the balloon 5, and inflates the balloon 5.

In the present embodiment, the regulating portion 30H and the balloon supporting portion 3 sandwich the edge portion 5b of the balloon 5, to prevent a flow of the fluid 7 between the edge portion 5b of the balloon 5 and the balloon supporting portion 3. In this way, the regulating portion 30H regulates inflation of the edge portion 5b, which is a part of the balloon 5.

Then, as illustrated in FIG. 10B, the edge portion 5a and the central portion 5c, which are a part of the balloon 5, are inflated. As the central portion 5c is inflated, the protection film 23 is pressed, is brought into contact with the cover glass 13 mounted on the mounting stand 10, and is bonded thereto. The protection film 23 is bonded to the edge portion 13Ea and the central portion 13Ec of the cover glass 13E and is not bonded to the edge portion 13Eb.

Note that, at this time, the surface 30H1 of the side surface of the regulating portion 30H on the side closer to the protection film 23 is preferably disposed above the cover glass 13E and is preferably disposed in a position overlapping the edge portion 13Eb or the central portion 13Ec. In this way, as the balloon 5 is inflated, the protection film 23 can be gradually bonded to the central portion 13Ec from the center to the end.

The surface 30H1 of the regulating portion 30H is disposed from the central portion 5c of the balloon 5 to the recessed portion 11 of the mounting stand 10 without a gap. Thus, the central portion 5c of the balloon 5 is inflated along the surface 30H1, and the protection film 23 is pressed and is brought into contact with the cover glass 13 mounted on the mounting stand 10.

Thus, a shape of the central portion 5c of the balloon 5 is easily controlled, and the protection film 23 can be more reliably bonded to the entire surface of the edge portion 13Ea and the central portion 13Ec of the cover glass 13E before the protection film 23 contacts the edge portion 13Eb of the cover glass 13E.

The protection film 23 is bonded to the entire surface of the edge portion 13Ea and the central portion 13Ec of the cover glass 13E. Next, as illustrated in FIG. 10C, the regulating portion driving portion 40a (see FIG. 1) slides the regulating portion 30H so as to reduce a contact area between the edge portion 5b of the balloon 5 and the regulating portion 30H by an instruction from the controller 50 (see FIG. 1).

The regulating portion 30H slides in an outward direction (X-axis positive direction). In this way, an area of the edge portion 5b of the balloon 5 where inflation is regulated by the regulating portion 30H is reduced, and an area in the X-axis direction of the inflating central portion 5c increases, which presses the protection film 23 from the central portion toward the edge.

As a result, the protection film 23 is gradually bonded to not only the edge portion 13Ea and the central portion 13Ec of the cover glass 13E but also the edge portion 13Eb curved so as to rise from the central portion 13Ec side toward the edge side. In the end, the protection film 23 is bonded to the entire bonded surface of the cover glass 13E that includes only one edge portion 13Eb of the four edge portions having a recessed shape and to which the protection film 23 is bonded.

According to the present embodiment, the protection film 23 can also be bonded to the cover glass 13E whose only one side of the edges facing each other is curved while air bubbles are prevented from being formed.

### Ninth Embodiment

A description follows regarding a ninth embodiment of the disclosure. Note that, for convenience of description, members having the same function as the members stated in the first to eighth embodiments are appended with the same reference signs, and the description thereof is omitted.

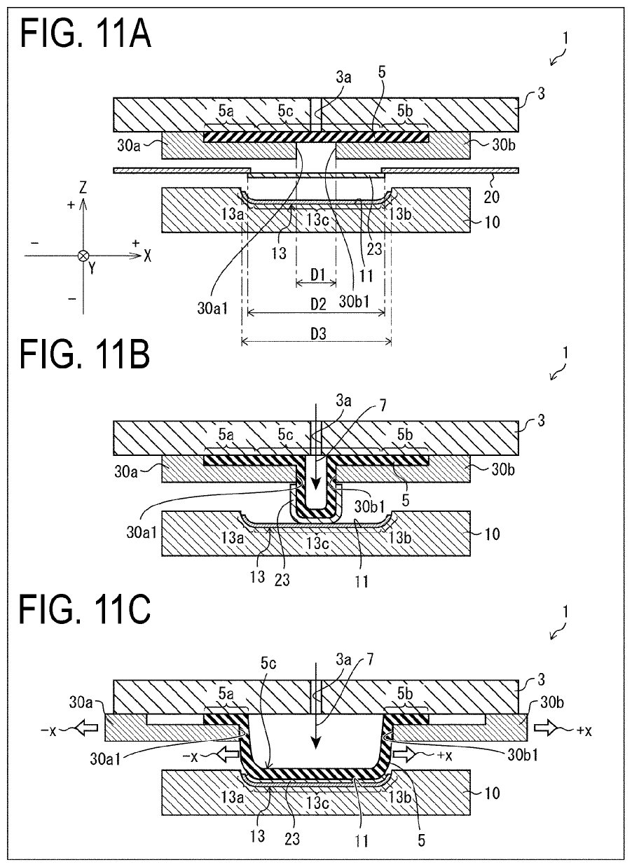

FIG. 11A is a cross-sectional view illustrating a configuration of a main portion of the laminating device 1 according to the ninth embodiment of the disclosure. FIG. 11B is a diagram illustrating a state where the balloon of the laminating device 1 illustrated in FIG. 11A is inflated. FIG. 11C is a diagram illustrating a state where the first regulating portion 30a and the second regulating portion 30b of the laminating device 1 illustrated in FIG. 11B are sliding.

As illustrated in FIG. 11, in the laminating device 1 illustrated in FIG. 1, the first regulating portion 30a and the second regulating portion 30b may cover not only the edge portions 5a, 5b of the balloon 5 but also a part of the central portion 5c.

In the present embodiment, the first regulating portion 30a contacts the edge portion 5a and a part of the central portion 5c of the balloon 5. The first regulating portion 30a and the balloon supporting portion 3 sandwich the edge portion 5a and the part of the central portion 5c. Furthermore, the second regulating portion 30b contacts the edge portion 5b and a part of the central portion 5c of the balloon 5. The second regulating portion 30b and the balloon supporting portion 3 sandwich the edge portion 5b and the part of the central portion 5c. In other words, the laminating device 1 illustrated in FIG. 11 has a width between the first regulating portion 30a and the second regulating portion 30b shorter than that in the laminating device 1 illustrated in FIG. 1.

In the present embodiment, as illustrated in FIG. 11A, a distance between the first regulating portion 30a and the second regulating portion 30b before the first regulating portion 30a and the second regulating portion 30b slide, namely, a distance between the surface 30a1 of the first regulating portion 30a and the surface 30b1 of the second regulating portion 30b is D1, which is shorter than the width D2 of the protection film 23.

The distance D1 between the first regulating portion 30a and the second regulating portion 30b before the first regulating portion 30a and the second regulating portion 30b slide is shorter than the width D3 of the cover glass 13.

As illustrated in FIGS. 11A and 11B, the fluid 7 is introduced through the through hole 3a formed in the balloon supporting portion 3, fills a space between the balloon supporting portion 3 and the balloon 5, and inflates the balloon 5.

However, the first regulating portion 30a and the balloon supporting portion 3 sandwich the edge portion 5a and the part of the central portion 5c of the balloon 5, to prevent a flow of the fluid 7 between the edge portion 5a and the part of the central portion 5c of the balloon 5, and the balloon supporting portion 3. In this way, the first regulating portion 30a regulates inflation of the edge portion 5a and the part of the central portion 5c, which are a part of the balloon 5.

The second regulating portion 30b and the balloon supporting portion 3 sandwich the edge portion 5b and the part of the central portion 5c of the balloon 5, to prevent a flow of the fluid 7 between the edge portion 5b and the part of the central portion 5c of the balloon 5, and the balloon supporting portion 3. In this way, the second regulating portion 30b regulates inflation of the edge portion 5b and the part of the central portion 5c, which are a part of the balloon 5.

Thus, as illustrated in FIG. 11B, the part of the central portion 5c, which is a part of the balloon 5, is inflated. As the part of the central portion 5c is inflated, the protection film 23 is pressed, is brought into contact with the cover glass 13 mounted on the mounting stand 10, and is bonded thereto. The protection film 23 is bonded to the part of the central portion 13c of the cover glass 13 and is not bonded to the other part of the central portion 13c and the edge portions 13a, 13b.

In other words, the surface 30a1 of the side surface of the first regulating portion 30a on the side closer to the protection film 23 is preferably disposed above the cover glass 13 and is preferably disposed in a position overlapping the edge portion 13a or the central portion 13c. The surface 30b1 of the side surface of the second regulating portion 30b on the side closer to the protection film 23 is preferably disposed above the cover glass 13 and is preferably disposed in a position overlapping the edge portion 13b or the central portion 13c.

In this way, as the balloon 5 is inflated, the protection film 23 can be gradually bonded to the central portion 13c from the center to the end.

Next, as illustrated in FIG. 11C, the regulating portion driving portion 40a (see FIG. 1) slides the first regulating portion 30a so as to reduce a contact area between the edge portion 5a of the balloon 5 and the first regulating portion 30a by an instruction from the controller 50 (see FIG. 1). The regulating portion driving portion 40b (see FIG. 1) slides the second regulating portion 30b so as to reduce a contact area between the edge portion 5b of the balloon 5 and the second regulating portion 30b by an instruction from the controller 50 (see FIG. 1).

In the present embodiment, a supply of the fluid 7 into a space between the balloon 5 and the balloon supporting portion 3 continues while the first regulating portion 30a and the second regulating portion 30b are sliding.

The first regulating portion 30a and the second regulating portion 30b slide in a direction away from each other. In the present embodiment, the first regulating portion 30a slides in the X-axis negative direction, and the second regulating portion 30b slides in the X-axis positive direction. In this way, areas of the edge portions 5a, 5b of the balloon 5 where inflation is regulated by the first regulating portion 30a and the second regulating portion 30b are reduced, and an area in the X-axis direction of the inflating central portion 5c increases, which presses the protection film 23 from the central portion toward the edges.

As a result, the protection film 23 is gradually bonded to not only the part of the central portion 13c of the cover glass 13 but also the edge portions 13a, 13b curved so as to rise from the central portion 13c side toward the edge side. In the end, the protection film 23 is bonded to the entire bonded surface of the cover glass 13 having a recessed shape and to which the protection film 23 is bonded.

In this way, the protection film 23 can be bonded to the cover glass 13 while air bubbles are prevented from being formed even in a case where a plane area of the cover glass 13 is small.

According to the present embodiment, the distance between the first regulating portion 30a and the second regulating portion 30b before the first regulating portion 30a and the second regulating portion 30b slide is short. Thus, the protection film 23 is pressed by the balloon 5 before the first regulating portion 30a and the second regulating portion 30b slide, and an area where the protection film 23 and the central portion 13c of the cover glass 13 contact each other is small. Accordingly, even in a case where an area of a curved region of the cover glass 13 is great, a level region thereof is small, or there is no level region thereof, the protection film 23 can be bonded to the cover glass 13 while air bubbles are prevented from being formed.

### Tenth Embodiment

A description follows regarding a tenth embodiment of the disclosure. Note that, for convenience of description, members having the same function as the members stated in the first to ninth embodiments are appended with the same reference signs, and the description thereof is omitted.

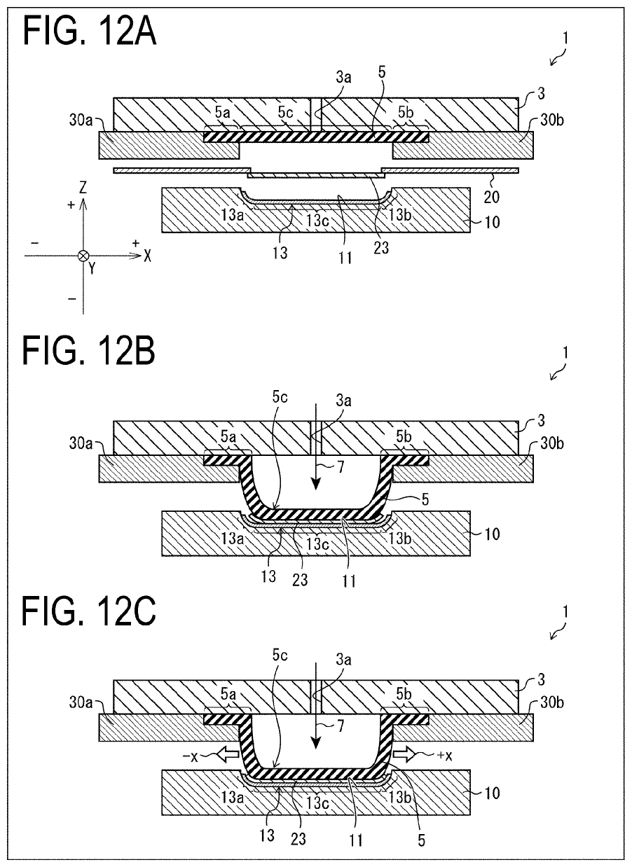

FIG. 12A is a cross-sectional view illustrating a configuration of a main portion of the laminating device 1 according to the tenth embodiment of the disclosure. FIG. 12B is a diagram illustrating a state where the balloon of the laminating device 1 illustrated in FIG. 12A is inflated. FIG. 12C is a diagram illustrating a state where the balloon of the laminating device 1 illustrated in FIG. 12B is further inflated.

As illustrated in FIGS. 12A to 12C, in the laminating device 1 illustrated in FIG. 1, the first regulating portion 30a and the second regulating portion 30b may be fixed without sliding.

In the present embodiment, the first regulating portion 30a contacts the edge portion 5a of the balloon 5. The first regulating portion 30a and the balloon supporting portion 3 sandwich the edge portion 5a. The second regulating portion 30b contacts the edge portion 5b of the balloon 5. The second regulating portion 30b and the balloon supporting portion 3 sandwich the edge portion 5b.

As illustrated in FIGS. 12A and 12B, the fluid 7 is introduced through the through hole 3a formed in the balloon supporting portion 3, fills a space between the balloon supporting portion 3 and the balloon 5, and inflates the balloon 5.

However, the first regulating portion 30a and the balloon supporting portion 3 sandwich the edge portion 5a of the balloon 5, to prevent a flow of the fluid 7 between the edge portion 5a of the balloon 5 and the balloon supporting portion 3. In this way, the first regulating portion 30a regulates inflation of the edge portion 5a, which is a part of the balloon 5.

Furthermore, the second regulating portion 30b and the balloon supporting portion 3 sandwich the edge portion 5b of the balloon 5, to prevent a flow of the fluid 7 between the edge portion 5b of the balloon 5 and the balloon supporting portion 3. In this way, the second regulating portion 30b regulates inflation of the edge portion 5b, which is a part of the balloon 5.

Thus, as illustrated in FIG. 12B, the central portion 5c, which is a part of the balloon 5, is inflated. As the central portion 5c is inflated, the protection film 23 is pressed, is brought into contact with the cover glass 13 mounted on the mounting stand 10, and is bonded thereto. The protection film 23 is bonded to the central portion 13c of the cover glass 13 and is not bonded to the edge portions 13a, 13b.

Next, as illustrated in FIG. 12C, the fluid 7 is supplied while the first regulating portion 30a and the second regulating portion 30b are fixed without sliding to inflate the central portion 5c, and an area in the X-axis direction of the inflating central portion 5c increases, which presses the protection film 23 from the central portion toward the edges.

As a result, the protection film 23 is gradually bonded to not only the central portion 13c of the cover glass 13 but also the edge portions 13a, 13b curved so as to rise from the central portion 13c side toward the edge side. In the end, the protection film 23 is bonded to the entire bonded surface of the cover glass 13 having a recessed shape and to which the protection film 23 is bonded.

Also in this way, air bubbles being formed are more reduced than a known laminating device that does not include the first regulating portion 30a and the second regulating portion 30b, and the protection film 23 can be bonded to the entire bonded surface of the cover glass 13 having a recessed shape and to which the protection film 23 is bonded.

Note that the present embodiment may have a configuration from which the regulating portion driving portions 40a, 40b are omitted because the first regulating portion 30a and the second regulating portion 30b do not slide in the X-axis direction.

### Eleventh Embodiment

A description follows regarding an eleventh embodiment of the disclosure. Note that, for convenience of description, members having the same function as the members stated in the first to tenth embodiments are appended with the same reference signs, and the description thereof is omitted.

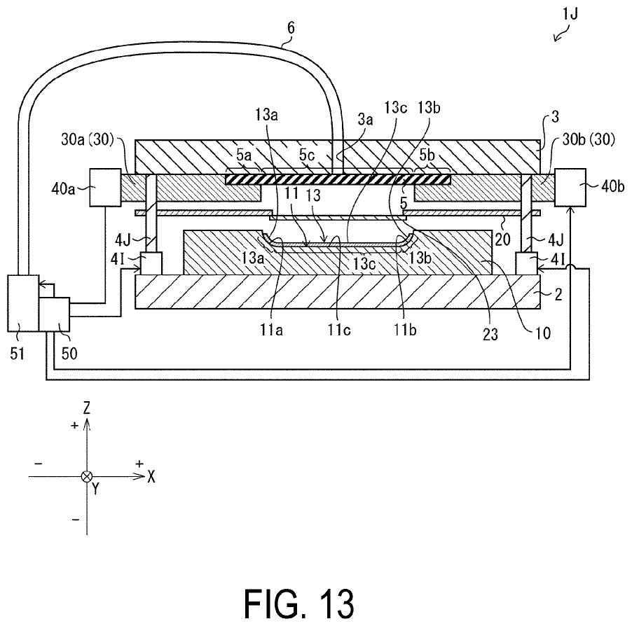

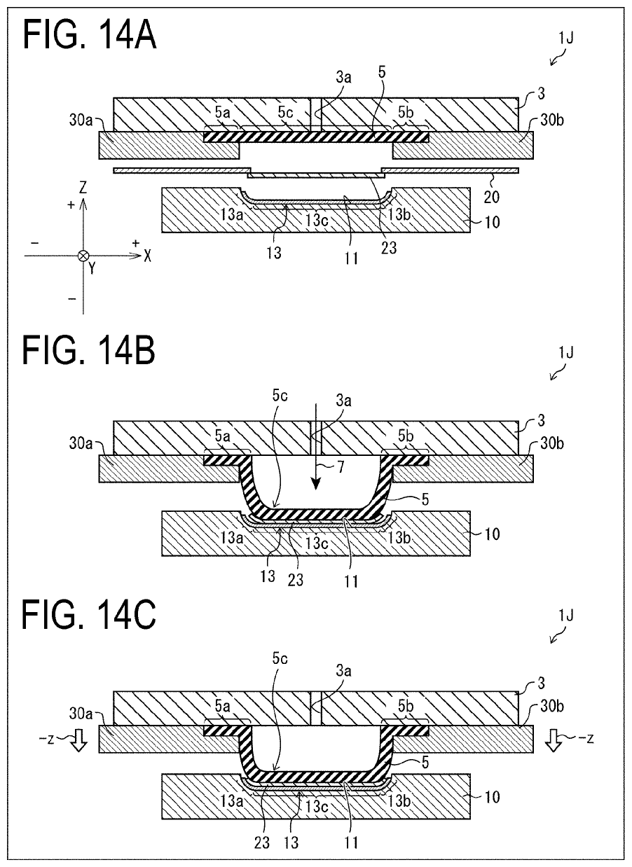

FIG. 13 is a cross-sectional view illustrating a configuration of a laminating device 1J according to the eleventh embodiment of the disclosure. FIG. 14A is a cross-sectional view illustrating a configuration of a main portion of the laminating device 1J according to the eleventh embodiment of the disclosure. FIG. 14B is a diagram illustrating a state where the balloon of the laminating device 1J illustrated in FIG. 14A is inflated. FIG. 14C is a diagram illustrating a state where the first regulating portion 30a and the second regulating portion 30b of the laminating device 1J illustrated in FIG. 14B are sliding.

The laminating device 1J as illustrated in FIG. 13 includes strut portions 4J instead of the strut portions 4 included in the laminating device 1 and further includes strut portion driving portions 4I. The other configuration of the laminating device 1J is the same as that of the laminating device 1.

The plurality of strut portions 4J support the balloon supporting portion 3 above the foundation 2. The strut portion driving portions 4I hold the strut portions 4J such that the strut portions 4J are slidable. The strut portion driving portions 4I each include a motor, and the motor is actuated to slide the strut portion 4J in the Z-axis direction when receiving an instruction from the controller 50. In this way, in the laminating device 1J, the balloon supporting portion 3, the balloon 5, the first regulating portion 30a, and the second regulating portion 30b can move in the Z-axis direction (direction toward or away from the mounting stand 10).

As illustrated in FIGS. 14A and 14B, the fluid 7 is introduced through the through hole 3a formed in the balloon supporting portion 3, fills a space between the balloon supporting portion 3 and the balloon 5, and inflates the balloon 5.

However, the first regulating portion 30a and the balloon supporting portion 3 sandwich the edge portion 5a of the balloon 5, to prevent a flow of the fluid 7 between the edge portion 5a of the balloon 5 and the balloon supporting portion 3. In this way, the first regulating portion 30a regulates inflation of the edge portion 5a, which is a part of the balloon 5.

Furthermore, the second regulating portion 30b and the balloon supporting portion 3 sandwich the edge portion 5b of the balloon 5, to prevent a flow of the fluid 7 between the edge portion 5b of the balloon 5 and the balloon supporting portion 3. In this way, the second regulating portion 30b regulates inflation of the edge portion 5b, which is a part of the balloon 5.

Thus, as illustrated in FIG. 14B, the central portion 5c, which is a part of the balloon 5, is inflated. As the central portion 5c is inflated, the protection film 23 is pressed, is brought into contact with the cover glass 13 mounted on the mounting stand 10, and is bonded thereto. The protection film 23 is bonded to the central portion 13c of the cover glass 13 and is not bonded to the edge portions 13a, 13b. Then, the controller 50 (see FIG. 13) stops the pressure adjusting portion 51 to stop a supply of the fluid 7 into a space between the balloon 5 and the balloon supporting portion 3.

Next, the controller 50 drives the strut portion driving portions 4I (see FIG. 13) and slides the balloon supporting portion 3 in a direction toward the mounting stand 10 (Z-axis negative direction). In this way, the fluid 7 in the inflated balloon 5 is compressed by the mounting stand 10. Thus, the central portion 5c of the balloon 5 is inflated, and an area in the X-axis direction of the inflating central portion 5c increases, which presses the protection film 23 from the central portion toward the edge.

As a result, the protection film 23 is gradually bonded to not only the central portion 13c of the cover glass 13 but also the edge portions 13a, 13b curved so as to rise from the central portion 13c side toward the edge side. In the end, the protection film 23 is bonded to the entire bonded surface of the cover glass 13 having a recessed shape and to which the protection film 23 is bonded.

Also in this way, air bubbles being formed are more reduced than a known laminating device that does not include the first regulating portion 30a and the second regulating portion 30b, and the protection film 23 can be bonded to the entire bonded surface of the cover glass 13 having a recessed shape and to which the protection film 23 is bonded.

Note that the present embodiment may have a configuration from which the regulating portion driving portions 40a, 40b are omitted because the first regulating portion 30a and the second regulating portion 30b do not slide in the X-axis direction.

After the protection film 23 is bonded to the central portion 13c of the cover glass 13, the balloon supporting portion 3 and the balloon 5 may not move and the first regulating portion 30a and the second regulating portion 30b may move in the direction toward the mounting stand 10. Also in this way, similarly, the protection film 23 can be gradually bonded to not only the central portion 13c of the cover glass 13 but also the edge portions 13a, 13b curved so as to rise from the central portion 13c side toward the edge side.

### Twelfth Embodiment

A description follows regarding a twelfth embodiment of the disclosure. Note that, for convenience of description, members having the same function as the members stated in the first to eleventh embodiments are appended with the same reference signs, and the description thereof is omitted.

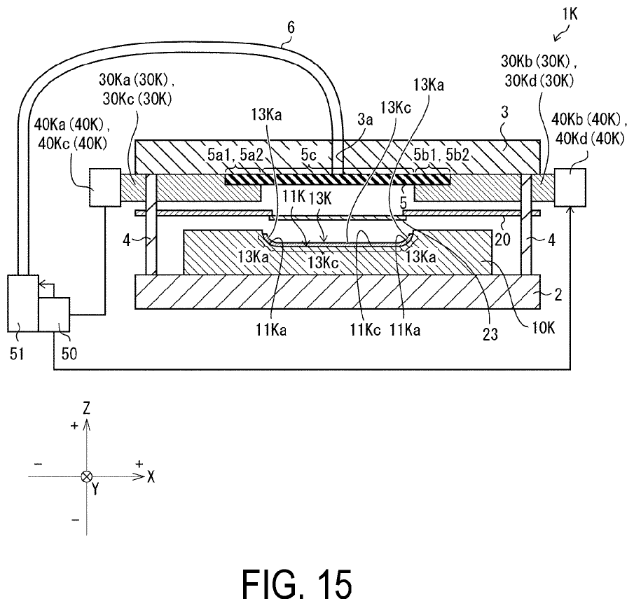

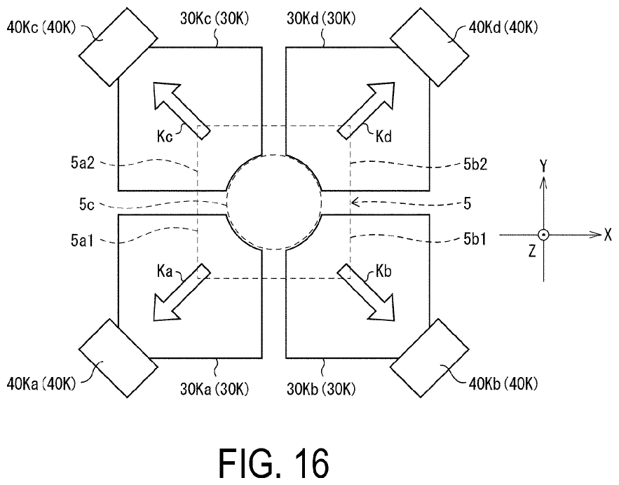

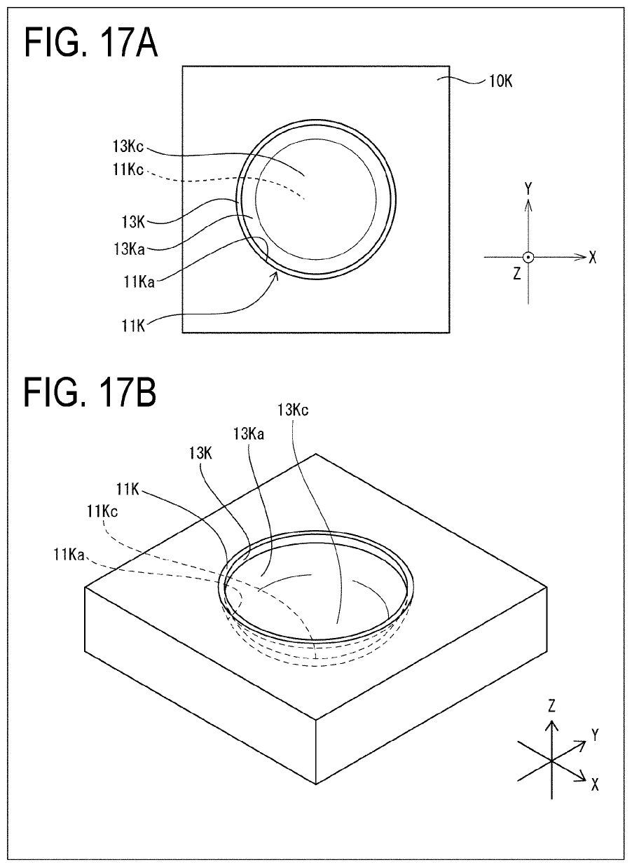

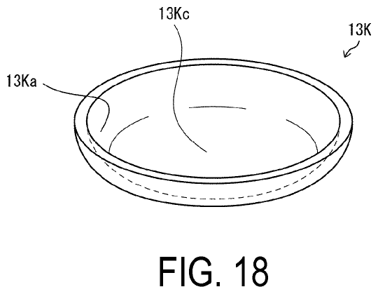

FIG. 15 is a cross-sectional view illustrating a configuration of a laminating device 1K according to the twelfth embodiment of the disclosure. FIG. 16 is a cross-sectional view illustrating a configuration of a regulating portion 30K of the laminating device 1K according to the twelfth embodiment of the disclosure. FIG. 17A is a plan view illustrating a configuration of a mounting stand 10K of the laminating device 1K according to the twelfth embodiment of the disclosure. FIG. 17B is a perspective view of the mounting stand 10K illustrated in FIG. 17A. FIG. 18 is a perspective view illustrating a configuration of a cover glass 13K mounted on the mounting stand 10K of the laminating device 1K according to the twelfth embodiment of the disclosure.

As illustrated in FIGS. 15 and 16, the laminating device 1K includes the mounting stand 10 and the regulating portion 30 included in the laminating device 1 and regulating portion driving portions 40Ka, 40Kb, 40Kc, and 40Kd. A cover glass 13K different from the cover glass 13 mounted on the mounting stand 10 of the laminating device 1 is mounted on the mounting stand 10K of the laminating device 1K. The other configuration of the laminating device 1K is the same as that of the laminating device 1.

As illustrated in FIGS. 17 and 18, the cover glass 13K has a round shape as a planar shape and has a recessed shape in cross section. In the cover glass 13K, a central portion 13Kc is plane, and an edge portion 13Ka surrounding the entire periphery of the central portion 13Kc has such a shape that gradually rises from the central portion 13Kc toward an edge.

As illustrated in FIGS. 15 and 17, a recessed portion 11K formed in the mounting stand 10K also has a round shape as a planar shape and has a recessed shape in cross section so as to correspond to the shape of the cover glass 13K. In the recessed portion 11K, a bottom surface 11Kc is plane, and an edge portion 11Ka surrounding the entire periphery of the bottom surface 11Kc has such a shape that gradually rises from the bottom surface 11Kc toward an edge.

As illustrated in FIGS. 15 and 16, a regulating portion 30K includes a first regulating portion 30Ka, a second regulating portion 30Kb, a third regulating portion 30Kc, and a fourth regulating portion 30Kd that face each other and are disposed at a distance.

The first regulating portion 30Ka, the second regulating portion 30Kb, the third regulating portion 30Kc, and the fourth regulating portion 30Kd contact and are attached to a surface of the balloon supporting portion 3 to which the balloon 5 is attached.

The first regulating portion 30Ka, the third regulating portion 30Kc, the fourth regulating portion 30Kd, and the second regulating portion 30Kb are disposed clockwise in this order.

The first regulating portion 30Ka, the third regulating portion 30Kc, the fourth regulating portion 30Kd, and the second regulating portion 30Kb contact edge portions around the central portion 5c of the balloon 5. The first regulating portion 30Ka, the third regulating portion 30Kc, the fourth regulating portion 30Kd, the second regulating portion 30Kb, and the balloon supporting portion 3 sandwich the contact edge portions.

Of the balloon 5, the first regulating portion 30Ka contacts an edge portion 5a1, the third regulating portion 30Kc contacts an edge portion 5a2, the fourth regulating portion 30Kd contacts an edge portion 5b2, and the second regulating portion 30Kb contacts an edge portion 5b1.

In this way, the first regulating portion 30Ka regulates inflation of the edge portion 5a1 of the balloon 5. The second regulating portion 30Kb regulates inflation of the edge portion 5b1 of the balloon 5. The third regulating portion 30Kc regulates inflation of the edge portion 5a2 of the balloon 5. The fourth regulating portion 30Kd regulates inflation of the edge portion 5b2 of the balloon 5.

Corner portions of the first regulating portion 30Ka, the second regulating portion 30Kb, the third regulating portion 30Kc, and the fourth regulating portion 30Kd adjacent to each other are preferably curved into a recessed shape so as to form a round shape when they contact each other. In this way, the balloon 5 can be prevented from being scratched when the first regulating portion 30Ka, the second regulating portion 30Kb, the third regulating portion 30Kc, and the fourth regulating portion 30Kd slide.

The regulating portion driving portions 40Ka, 40Kb, 40Kc, 40Kd hold the regulating portion 30K such that the regulating portion 30K is slidable. The regulating portion driving portion 40Ka holds the first regulating portion 30Ka such that the first regulating portion 30Ka is slidable. The regulating portion driving portion 40Kb holds the second regulating portion 30Kb such that the second regulating portion 30Kb is slidable. The regulating portion driving portion 40Kc holds the third regulating portion 30Kc such that the third regulating portion 30Kc is slidable. The regulating portion driving portion 40Kd holds the fourth regulating portion 30Kd such that the fourth regulating portion 30Kd is slidable.

The regulating portion driving portions 40Ka, 40Kb, 40Kc, 40Kd each include a motor, and the motor is actuated to slide the first regulating portion 30Ka, the second regulating portion 30Kb, the third regulating portion 30Kc, or the fourth regulating portion 30Kd when receiving an instruction from the controller 50.

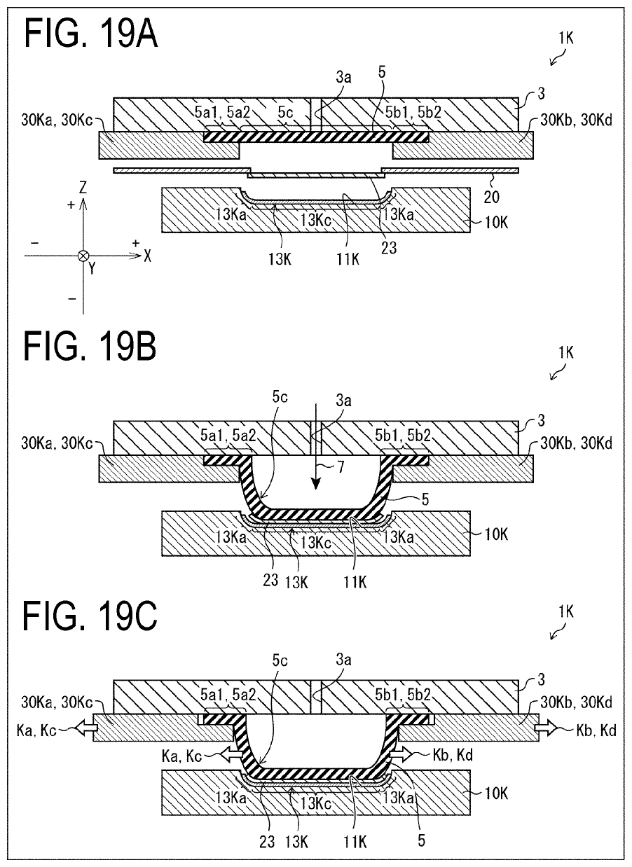

FIG. 19A is a cross-sectional view illustrating a configuration of a main portion of the laminating device 1K according to the twelfth embodiment of the disclosure. FIG. 19B is a diagram illustrating a state where the balloon of the laminating device 1K illustrated in FIG. 19A is inflated. FIG. 19C is a diagram illustrating a state where the first regulating portion 30Ka, the second regulating portion 30Kb, the third regulating portion 30Kc, and the fourth regulating portion 30Kd of the laminating device 1K illustrated in FIG. 19B are sliding.

As illustrated in FIGS. 19A and 19B, the fluid 7 is introduced through the through hole 3a formed in the balloon supporting portion 3, fills a space between the balloon supporting portion 3 and the balloon 5, and inflates the balloon 5.

However, the first regulating portion 30Ka and the balloon supporting portion 3 sandwich the edge portion 5a1 of the balloon 5, to prevent a flow of the fluid 7 between the edge portion 5a1 of the balloon 5 and the balloon supporting portion 3. In this way, the first regulating portion 30Ka regulates inflation of the edge portion 5a1, which is a part of the balloon 5.

Furthermore, the second regulating portion 30Kb and the balloon supporting portion 3 sandwich the edge portion 5b1 of the balloon 5, to prevent a flow of the fluid 7 between the edge portion 5b1 of the balloon 5 and the balloon supporting portion 3. In this way, the second regulating portion 30Kb regulates inflation of the edge portion 5b1, which is a part of the balloon 5.

Furthermore, the third regulating portion 30Kc and the balloon supporting portion 3 sandwich the edge portion 5a2 of the balloon 5, to prevent a flow of the fluid 7 between the edge portion 5a2 of the balloon 5 and the balloon supporting portion 3. In this way, the third regulating portion 30Kc regulates inflation of the edge portion 5a2, which is a part of the balloon 5.

Furthermore, the fourth regulating portion 30Kd and the balloon supporting portion 3 sandwich the edge portion 5b2 of the balloon 5, to prevent a flow of the fluid 7 between the edge portion 5b2 of the balloon 5 and the balloon supporting portion 3. In this way, the fourth regulating portion 30Kd regulates inflation of the edge portion 5b2, which is a part of the balloon 5.

Also in this way, inflation between the edge portions 5a1, 5a2, 5b1, 5b2 of the balloon 5 is regulated.

Then, as illustrated in FIG. 19B, the central portion 5c, which is a part of the balloon 5, surrounded by the edge portions 5a1, 5a2, 5b1, 5b2 is inflated. As the central portion 5c is inflated, the protection film 23 is pressed and is brought into contact with the cover glass 13K mounted on the mounting stand 10K.

The protection film 23 is bonded to the central portion 13Kc of the cover glass 13K and is not bonded to the edge portion 13Ka. Then, the controller 50 (see FIG. 15) stops the pressure adjusting portion 51 to stop a supply of the fluid 7 into a space between the balloon 5 and the balloon supporting portion 3.

Next, as illustrated in FIG. 19C, the regulating portion driving portion 40Ka (see FIGS. 15 and 16) slides the first regulating portion 30Ka so as to reduce a contact area between the edge portion 5a1 of the balloon 5 and the first regulating portion 30Ka by an instruction from the controller 50 (see FIG. 15). The regulating portion driving portion 40Kb (see FIGS. 15 and 16) slides the second regulating portion 30Kb so as to reduce a contact area between the edge portion 5b1 of the balloon 5 and the second regulating portion 30Kb by an instruction from the controller 50 (see FIG. 15). The regulating portion driving portion 40Kc (see FIGS. 15 and 16) slides the third regulating portion 30Kc so as to reduce a contact area between the edge portion 5a2 of the balloon 5 and the third regulating portion 30Kc by an instruction from the controller 50 (see FIG. 15). The regulating portion driving portion 40Kd (see FIGS. 15 and 16) slides the fourth regulating portion 30Kd so as to reduce a contact area between the edge portion 5b2 of the balloon 5 and the fourth regulating portion 30Kd by an instruction from the controller 50 (see FIG. 15).

The first regulating portion 30Ka, the second regulating portion 30Kb, the third regulating portion 30Kc, and the fourth regulating portion 30Kd slide in a direction away from each other. In the present embodiment, the first regulating portion 30Ka slides in a direction of an arrow Ka illustrated in FIG. 16 (X-negative Y-negative direction). The second regulating portion 30Kb slides in a direction of an arrow Kb illustrated in FIG. 16 (X-positive Y-negative direction). The third regulating portion 30Kc slides in a direction of an arrow Kc illustrated in FIG. 16 (X-negative Y-positive direction). The fourth regulating portion 30Kd slides in a direction of an arrow Kd illustrated in FIG. 16 (X-positive Y-positive direction).

In this way, areas of the edge portions 5a1, 5b1, 5a2, 5b2 of the balloon 5 where inflation is regulated by the first regulating portion 30Ka, the second regulating portion 30Kb, the third regulating portion 30Kc, and the fourth regulating portion 30Kd are reduced, and an area in the XY direction of the inflating central portion 5c increases, which presses the protection film 23 from the central portion toward the edge.

As a result, the protection film 23 is gradually bonded to not only the central portion 13Kc of the cover glass 13K but also the edge portion 13Ka curved in a round shape so as to rise from the central portion 13Kc side toward the edge side. In the end, the protection film 23 is bonded to the entire bonded surface of the cover glass 13K having a recessed shape and to which the protection film 23 is bonded.

Note that the first regulating portion 30Ka, the second regulating portion 30Kb, the third regulating portion 30Kc, and the fourth regulating portion 30Kd may contact the mounting stand 10K or may be disposed between the balloon supporting portion 3 and the mounting stand 10 and disposed away from each of them.

The first regulating portion 30Ka, the second regulating portion 30Kb, the third regulating portion 30Kc, and the fourth regulating portion 30Kd may slide in the direction toward the mounting stand 10K in the Y direction instead of sliding in the XY direction, or they may not slide.

Furthermore, the number of the regulating portion 30K is not limited to four, and three or five or more may be disposed to be adjacent to each other.

### Supplement

A laminating device according to an aspect 1 of the disclosure includes: a mounting stand on which a bonded member is mounted, the bonded member including a surface having a recessed shape and to which a film is bonded; a holding portion configured to hold the film facing the bonded member mounted on the mounting stand; a balloon disposed opposite to the bonded member with respect to the film, made of an elastic material inflated by a flow of a fluid, and configured to press the film by inflating; and a regulating portion configured to regulate inflation of a part of the balloon by contacting the balloon before inflation of the balloon or in a process of inflation of the balloon.

With the configuration above, the regulating portion regulates inflation of the part of the balloon by contacting the balloon before inflation of the balloon or in the process of inflation of the balloon. In this way, the film pressed by the balloon is gradually bonded to the recessed surface of the bonded member. Thus, even in a case where the surface of the bonded member to which the film is bonded is a recessed surface, air bubbles can be prevented from being formed between the film and the bonded member.

In a laminating device according to an aspect 2 of the disclosure in the aspect 1 above, the regulating portion overlaps an edge portion of the balloon. In this way, the balloon contacts the regulating portion before inflation of the balloon or in the process of inflation of the balloon, and inflation of the balloon at the contact spot is regulated.

In a laminating device according to an aspect 3 of the disclosure in the aspect 1 or 2 above, a balloon supporting portion configured to support the balloon to be inflated may be included, and the regulating portion may contact an edge portion of the balloon before inflation of the balloon, and the edge portion may be located between the balloon supporting portion and the regulating portion. With the configuration above, the regulating portion regulates inflation of the balloon at the contact spot.

In a laminating device according to an aspect 4 of the disclosure in the aspect 1 or 2 above, a balloon supporting portion configured to support the balloon to be inflated may be included, and the regulating portion may not contact an edge portion of the balloon before inflation of the balloon and may contact the balloon in the process of inflation of the balloon. With the configuration above, the balloon contacts the regulating portion in the process of inflation of the balloon, and inflation of the balloon at the contact spot is regulated.

In a laminating device according to an aspect 5 of the disclosure in the aspects 1, 2, 4 above, the regulating portion may contact the mounting stand. With the configuration above, the film can be bonded to the bonded member while inflation of the balloon is accurately controlled. Thus, the film can be bonded to the bonded member while air bubbles are further prevented from being formed.

In a laminating device according to an aspect 6 of the disclosure in the aspects 1 to 5 above, the regulating portion may slide in a direction to reduce a region where inflation of a part of the balloon is regulated after inflation of the balloon starts. In this way, the film can be bonded to the bonded member while an area of inflation of the balloon is gradually increased. Thus, the film can be bonded to the bonded member while air bubbles are prevented from being formed.

In a laminating device according to an aspect 7 of the disclosure in the aspects 1 to 6 above, the regulating portion may include a first regulating portion and a second regulating portion aligned with each other, and the first regulating portion and the second regulating portion may regulate inflation in different regions of the balloon. With the configuration above, inflation at at least two different spots of the balloon can be controlled. Thus, the film can be bonded to the bonded member while air bubbles are further prevented from being formed.

In a laminating device according to an aspect 8 of the disclosure in the aspect 7 above, the first regulating portion and the second regulating portion may slide in a direction away from each other after inflation of the balloon starts. With the configuration above, the film can be bonded to the bonded member while inflation of the balloon is controlled. Thus, the film can be bonded to the bonded member while air bubbles are prevented from being formed.

In a laminating device according to an aspect 9 of the disclosure in the aspect 7 above, the first regulating portion and the second regulating portion may slide in a direction toward the mounting stand after inflation of the balloon starts. With the configuration above, the film can also be bonded to the bonded member while inflation of the balloon is controlled. Thus, the film can be bonded to the bonded member while air bubbles are prevented from being formed.

In a laminating device according to an aspect 10 of the disclosure in the aspect 8 or 9 above, a distance D1 between the first regulating portion and the second regulating portion before the first regulating portion and the second regulating portion slide may be greater than a width D2 of the film.

In a laminating device according to an aspect 11 of the disclosure in the aspects 8 to 10 above, the distance D1 between the first regulating portion and the second regulating portion before the first regulating portion and the second regulating portion slide may be equal to or less than a width D3 of the bonded member.

In a laminating device according to an aspect 12 of the disclosure in the aspect 8 or 9 above, a distance D1 between the first regulating portion and the second regulating portion before the first regulating portion and the second regulating portion slide may be less than a width D2 of the film.

In a laminating device according to an aspect 13 of the disclosure in the aspects 7 to 12 above, the regulating portion may further include a third regulating portion and a fourth regulating portion aligned with each other, the third regulating portion may regulate inflation in a region of the balloon different from those of the first regulating portion, the second regulating portion, and the fourth regulating portion, and the fourth regulating portion may regulate inflation in a region of the balloon different from those of the first regulating portion, the second regulating portion, and the third regulating portion. With the configuration above, inflation at at least four different spots of the balloon can be controlled. Thus, the film can be bonded to the bonded member while air bubbles are further prevented from being formed.

A method for producing a layered body according to an aspect 14 of the disclosure is a method for producing a layered body formed by a film bonded to a bonded member. The method for producing a layered body includes: holding the film facing the bonded member, the bonded member including a surface having a recessed shape and to which the film is bonded; pressing the film by inflating a balloon disposed opposite to the bonded member with respect to the film and made of an elastic material inflated by a flow of a fluid; and regulating inflation of a part of the balloon by contacting the balloon before inflation of the balloon or in a process of inflation of the balloon.

Thus, even in a case where the surface of the bonded member to which the film is bonded is a recessed surface, the layered body can be manufactured while air bubbles are prevented from being formed between the film and the bonded member.

The disclosure is not limited to each of the embodiments stated above, and various modifications may be implemented within a range not departing from the scope of the claims. Embodiments obtained by appropriately combining technical approaches stated in each of the different embodiments also fall within the scope of the technology of the present invention. Moreover, novel technical features may be formed by combining the technical approaches stated in each of the embodiments.

### REFERENCE SIGNS LIST

1, 1B to 1K Laminating device
2 Foundation
3 Balloon supporting portion
3a Through hole
4, 4J Strut portion
4I Strut portion driving portion
5 Balloon
5a, 5b, 5a1, 5b1, 5a2, 5b2 Edge portion
5c Central portion
6 Pipe
7 Fluid
10, 10K Mounting stand
11, 11K Recessed portion
11c Bottom surface
13, 13E, 13K Cover glass (bonded member)
20 Holding portion
23 Protection film (film)
30, 30E, 30H, 30K Regulating portion
30a, 30Da, 30Da1, 30H, 30Ka First regulating portion (regulating portion)
30b, 30Db, 30Db1, 30Kb Second regulating portion (regulating portion)
30Kc Third regulating portion (regulating portion)
30Kd Fourth regulating portion (regulating portion)
40a, 40b, 40Ka to 40Kd Regulating portion driving portion
50 Controller
51 Pressure adjusting portion

1-5. (canceled)

6. A laminating device comprising:
a mounting stand on which a bonded member is mounted, the bonded member including a surface having a recessed shape and to which a film is bonded;
a holding portion configured to hold the film facing the bonded member mounted on the mounting stand;
a balloon disposed opposite to the bonded member with respect to the film, made of an elastic material inflated by a flow of a fluid, and configured to press the film by inflating; and
a regulating portion configured to regulate inflation of a part of the balloon by contacting the balloon before inflation of the balloon or in a process of inflation of the balloon,
wherein the regulating portion slides in a direction to reduce a region where inflation of a part of the balloon is regulated after inflation of the balloon starts.

7. The laminating device according to claim 6,
wherein the regulating portion includes a first regulating portion and a second regulating portion aligned with each other, and
the first regulating portion and the second regulating portion regulate inflation in different regions of the balloon.

8. The laminating device according to claim 7,
wherein the first regulating portion and the second regulating portion slide in a direction away from each other after inflation of the balloon starts.

9. The laminating device according to claim 7,
wherein the first regulating portion and the second regulating portion slide in a direction toward to the mounting stand after inflation of the balloon starts.

10. The laminating device according to claim 8,
wherein a distance D1 between the first regulating portion and the second regulating portion before the first regulating portion and the second regulating portion slide is greater than a width D2 of the film.

11. The laminating device according to claim 8,
wherein the distance D1 between the first regulating portion and the second regulating portion before the first regulating portion and the second regulating portion slide is equal to or less than a width D3 of the bonded member.

12. The laminating device according to claim 8,
wherein the distance D1 between the first regulating portion and the second regulating portion before the first regulating portion and the second regulating portion slide is less than the width D2 of the film.

13. The laminating device according to claim 7,
wherein the regulating portion further includes a third regulating portion and a fourth regulating portion aligned with each other,
the third regulating portion regulates inflation in a region of the balloon different from those of the first regulating portion, the second regulating portion, and the fourth regulating portion, and
the fourth regulating portion regulates inflation in a region of the balloon different from those of the first regulating portion, the second regulating portion, and the third regulating portion.

14. (canceled)

15. A laminating device comprising:
a mounting stand on which a bonded member is mounted, the bonded member including a surface having a recessed shape and to which a film is bonded;
a holding portion configured to hold the film facing the bonded member mounted on the mounting stand;
a balloon disposed opposite to the bonded member with respect to the film, made of an elastic material inflated by a flow of a fluid, and configured to press the film by inflating; and
a regulating portion configured to regulate inflation of a part of the balloon by contacting the balloon before inflation of the balloon or in a process of inflation of the balloon,
wherein the regulating portion includes a first regulating portion and a second regulating portion aligned with each other,
the first regulating portion and the second regulating portion regulate inflation in different regions of the balloon, and
the first regulating portion and the second regulating portion slide in a direction away from each other after inflation of the balloon starts.

16. The laminating device according to claim 15,
wherein a distance D1 between the first regulating portion and the second regulating portion before the first regulating portion and the second regulating portion slide is greater than a width D2 of the film.

17. The laminating device according to claim 15,
wherein a distance D1 between the first regulating portion and the second regulating portion before the first regulating portion and the second regulating portion slide is equal to or less than a width D3 of the bonded member.

18. The laminating device according to claim 15,
wherein a distance D1 between the first regulating portion and the second regulating portion before the first regulating portion and the second regulating portion slide is less than a width D2 of the film.

19. The laminating device according to claim 15,
wherein the regulating portion further includes a third regulating portion and a fourth regulating portion aligned with each other,
the third regulating portion regulates inflation in a region of the balloon different from those of the first regulating portion, the second regulating portion, and the fourth regulating portion, and
the fourth regulating portion regulates inflation in a region of the balloon different from those of the first regulating portion, the second regulating portion, and the third regulating portion.

20. A laminating device comprising:
a mounting stand on which a bonded member is mounted, the bonded member including a surface having a recessed shape and to which a film is bonded;
a holding portion configured to hold the film facing the bonded member mounted on the mounting stand;
a balloon disposed opposite to the bonded member with respect to the film, made of an elastic material inflated by a flow of a fluid, and configured to press the film by inflating; and
a regulating portion configured to regulate inflation of a part of the balloon by contacting the balloon before inflation of the balloon or in a process of inflation of the balloon,
wherein the regulating portion includes a first regulating portion and a second regulating portion aligned with each other,
the first regulating portion and the second regulating portion regulate inflation in different regions of the balloon, and
the first regulating portion and the second regulating portion slide in a direction toward the mounting stand after inflation of the balloon starts.

21. The laminating device according to claim 20,
wherein a distance D1 between the first regulating portion and the second regulating portion before the first regulating portion and the second regulating portion slide is greater than a width D2 of the film.

22. The laminating device according to claim 6,
wherein the regulating portion overlaps an edge portion of the balloon.

23. The laminating device according to claim 6,
wherein a balloon supporting portion configured to support the balloon to be inflated is included, and
the regulating portion contacts an edge portion of the balloon before inflation of the balloon, and the edge portion is located between the balloon supporting portion and the regulating portion.

24. The laminating device according to claim 6,
wherein a balloon supporting portion configured to support the balloon to be inflated is included, and
the regulating portion does not contact an edge portion of the balloon before inflation of the balloon and contacts the balloon in the process of inflation of the balloon.

25. The laminating device according to claim 6,
wherein the regulating portion contacts the mounting stand.
